(19) United States
(12) Patent Application Publication
(10) Pub. No.: US 2024/0093386 A1
(43) Pub. Date: Mar. 21, 2024

(54) CHLORINATOR

(71) Applicant: Magen Eco Energy A.C.S Ltd, D N Hanegev (IL)

(72) Inventors: Ronen BAR BUZAGLO, Ein Habsor (IL); Nitzan MORSE, Kibbutz Magen (IL); Rani GOLDIN, Kibbutz Nir Yitzhak (IL)

(73) Assignee: Magen Eco Energy A.C.S Ltd, D N Hanegev (IL)

(21) Appl. No.: 18/467,288

(22) Filed: Sep. 14, 2023

(30) Foreign Application Priority Data
Sep. 16, 2022 (NL) 2033059

(51) Int. Cl. C25B 1/26; C25B 9/17; C25B 9/60; C25B 15/02; C25B 15/08

(52) U.S. Cl. CPC C25B 1/26; C25B 9/17; C25B 9/60; C25B 15/02; C25B 15/08; E04H 4/1209

(57) ABSTRACT

A chlorinator includes an electrode assembly and a housing. The housing includes a first water flow opening, a second water flow opening, an electrolysis chamber for accommodating the electrode assembly, a sampling chamber for selectively enabling sampling of water entering the housing in operation of the chlorinator, and a flow stream separator. The flow stream separator includes a partition wall axially extending between a first partition edge and a second partition edge. The partition wall separates the housing internal volume into a main channel and an auxiliary channel. The main channel extends axially between the first partition edge and the second partition edge, and wholly accommodates therein the electrolysis chamber on a first side of the partition wall. The auxiliary channel extends axially between the first partition edge and the second partition edge and wholly accommodates therein the sampling chamber on a second side of the partition wall. The flow separator separates water flowing into the housing into a main water stream flowing through the main channel, and thus through the electrode assembly, and an auxiliary water stream flowing through the auxiliary channel, and thus through the sampling chamber.

### TECHNOLOGICAL FIELD

The presently disclosed subject matter relates to, chlorinators, for example to pool chlorinators, in particular to chlorinators configured for producing chlorine-based sanitizing agents by electrolysis.

### BACKGROUND

Swimming pools are commonly treated with a sanitizing agent, such as chlorine for example, in order to maintain a clean swimming environment. The sanitizing agent can be dispensed at a suitable rate to the water by a dedicated dispenser as a liquid or a solid, such as in tablet form.

The sanitizing agent can also be produced within the water itself. For example, salt may be added to the swimming water at a tolerable level. The salted water is directed into a chlorinator which produces the sanitizing agent through electrolysis. The water with the newly-produced sanitizing agent is then directed back into the pool.

Similarly, other bodies of water are also sometimes with a sanitizing agent.

### GENERAL DESCRIPTION

According to a first aspect of the presently disclosed subject matter, there is provided a housing for use in a chlorinator, the chlorinator being operable with an electrode assembly accommodated in the housing to produce one or more sanitizing agents from solute dissolved in water in operation of the chlorinator, said housing comprising a first water flow opening, a second water flow opening, an electrolysis chamber, a sampling chamber, at least one acid entry port, and a sampling chamber shielding arrangement:
the first water flow opening being axially spaced from the second water flow opening and defining therebetween a housing internal volume, the first water flow opening and the second water flow opening configured for being coupled to a source of water in operation of the chlorinator;
said electrolysis chamber being configured for accommodating therein at least a portion of the electrode assembly;
the at least one acid entry port being configured for selectively enabling introduction of an acid therethrough into the electrolysis chamber,;
the sampling chamber shielding arrangement being transversely interposed between the at least one acid entry port and the sampling chamber;
the sampling chamber shielding arrangement being configured for preventing transverse fluid communication therethrough, in particular for preventing transverse fluid communication through the shielding arrangement between the at least one acid entry port and the sampling chamber.

For example, the at least one acid entry port is configured for selectively enabling introduction of an acid therethrough transversely and/or directly into the electrolysis chamber. Additionally or alternatively, for example, the at least one acid entry port is in direct fluid communication transversely with the electrolysis chamber.

The sampling chamber shielding arrangement is thus configured for minimizing or preventing spill of the acid into the sampling chamber following introduction of the acid into the housing, in particular following introduction of the acid into the electrolysis chamber, via the at least one acid entry port.

For example, the sampling chamber comprises at least one sampling port, configured for enabling at least one sensor to be introduced into the sampling chamber from an outside of the housing.

For example, the sampling chamber shielding arrangement comprises a first axial edge, a second axial edge and a shielding wall, the shielding wall axially extending between the first axial edge and the second axial edge, wherein the at least one acid entry port is axially intermediate with respect to each one of the first axial edge and the second axial edge.

For example, the shielding wall comprises a first side and an opposite facing second side, wherein the shielding wall separates the housing internal volume into a main channel and an auxiliary channel, the main channel extending axially between said first axial edge and said second axial edge, and wholly accommodating therein the electrolysis chamber on said first side of the shielding wall, the auxiliary channel extending axially between the first axial edge and the second axial edge and wholly accommodating therein the sampling chamber on said second side of the shielding wall. For example, the at least one acid port is wholly located in said main channel. For example, the shielding wall transversely separates the housing internal volume into the main channel and the auxiliary channel.

Additionally or alternatively, for example, the shielding wall is impermeable to water.

Additionally or alternatively, for example, the at least one acid entry port is transversely spaced from the shielding wall by a first vertical spacing. For example, the shielding wall has a shielding wall axial length, and a ratio of the first vertical spacing to the shielding wall axial length is between 0.05 to 0.15.

Additionally or alternatively, for example, the first axial edge extends away from the at least one acid entry port towards the first water flow opening by a first axial distance. For example, said first axial distance is about 30% of an axial dimension of the housing.

Additionally or alternatively, for example, the second axial edge extends away from the at least one acid entry port and towards the second water flow opening by a second axial distance. For example, said second axial distance is about 30% of an axial dimension of the housing.

Additionally or alternatively, for example, said first axial edge has a first edge axially extending cross-section parallel to a centerline of the housing.

Additionally or alternatively, for example, said second axial edge has a second edge axially extending cross-section parallel to a centerline of the housing.

Additionally or alternatively, for example, said shielding wall has a shielding wall axial cross-section parallel to a centerline of the housing.

Additionally or alternatively, for example, said first edge defines a first auxiliary channel opening having a first auxiliary channel transverse cross-sectional area, and a first main channel opening having a first main channel transverse cross-sectional area.

For example, a ratio of said first main channel transverse cross-sectional area to said first auxiliary channel transverse cross-sectional area is in the range between about 7 to about 15. For example, a ratio of said first main channel transverse cross-sectional area to said first auxiliary channel transverse cross-sectional area is any one of: 15, 14, 13, 12, 11, 10, 9, 8, 7.

Additionally or alternatively, for example, said second edge defines a second auxiliary channel opening having a second auxiliary channel transverse cross-sectional area, and a second main channel opening having a second main channel transverse cross-sectional area. For example, a ratio of said second main channel transverse cross-sectional area to said second auxiliary channel transverse cross-sectional area is in the range between about 7 to about 15. For example, a ratio of said second main channel transverse cross-sectional area to said second auxiliary channel transverse cross-sectional area is any one of: 15, 14, 13, 12, 11, 10, 9, 8, 7.

Additionally or alternatively, for example, the shielding arrangement is further configured as a flow separator, the flow separator being configured in operation of the chlorinator for separating at the first axial edge water flowing into the housing via the first water flow opening into a main water stream flowing through the main channel and an auxiliary water stream flowing through the auxiliary channel. For example, the flow separator is further configured in operation of the chlorinator for separating at the second axial edge water flowing into the housing via the second water flow opening into the main water stream flowing through the main channel and the auxiliary water stream flowing through the auxiliary channel.

Additionally or alternatively, for example, the shielding arrangement is configured for preventing any transverse cross-flow between the main channel and the auxiliary channel, at any location between the first axial edge and the second axial edge.

Additionally or alternatively, for example, the main channel wholly accommodates therein the electrolysis chamber on said first side, wherein said first side is a first transverse side of the shielding wall.

Additionally or alternatively, for example, the auxiliary channel wholly accommodates therein the sampling chamber on said second side, wherein said second side is a second transverse side of the shielding wall, the second transverse side being opposite facing with respect to the first transverse side.

Additionally or alternatively, for example, the first axial edge is spaced from the first water flow opening by a first axial spacing.

Additionally or alternatively, for example, the second axial edge is spaced from the second water flow opening by a second axial spacing.

Additionally or alternatively, for example, the first electrolysis chamber axial end is axially spaced with respect to the first water flow opening by a third axial spacing, and wherein the second electrolysis chamber axial end being is axially spaced with respect to the second water flow opening a fourth axial spacing. For example, a ratio of said first axial spacing to said third axial spacing is in any one of the following ranges: 0.2 to 0.8; 0.5 to 0.7; 0.2 to 0.5. For example, a ratio of said second axial spacing to said fourth axial spacing is in any one of the following ranges: 0.2 to 0.8; 0.5 to 0.7; 0.2 to 0.5.

Additionally or alternatively, for example, said sampling chamber comprises a flow diverter configured for directing the auxiliary water stream from the first axial edge to a bottom section of the sampling chamber, and for directing the auxiliary water stream from said bottom section to the second axial edge, the flow diverter including a barrier wall in the sampling chamber and projecting transversely in the auxiliary channel with respect to a longitudinal axis of the housing. For example, said flow diverter is configured for causing the auxiliary water stream to change direction by an angle greater than 60° degrees when flowing through the auxiliary channel from the first axial edge to the bottom section. Additionally or alternatively, for example, said barrier wall transversely projects away from the second side of the shielding wall. Additionally or alternatively, for example, the sampling chamber (optionally including the flow diverter) is configured for providing a water trap in operation of the respective chlorinator.

Additionally or alternatively, for example, said sampling chamber comprises a at least one, and for example a plurality of, said sampling ports, each said port configured for enabling a sensor to be introduced into the sampling chamber from an outside of the housing.

Additionally or alternatively, for example, the sampling chamber is laterally displaced with respect to the electrolysis chamber.

Additionally or alternatively, for example, the sampling chamber comprises a laterally disposed access hatch.

Additionally or alternatively, for example, the housing comprises a single said acid entry port.

Additionally or alternatively, for example, the housing is configured for being coupled to an inlet conduit and to an outlet conduit of a water recirculation circuit, alternately in each one of a first installation configuration and a second installation configuration, wherein:
in said first installation configuration the first water flow opening operates as a water inlet port and the second water flow opening operates as a water outlet port for the water, such that the first water flow opening is connected to an upstream portion of the water recirculation circuit and receives water flow therefrom, while the second water flow opening is connected to a downstream portion of the water recirculation circuit and delivers water flow thereto;
in second first installation configuration the second water flow opening operates as a water inlet port and the first water flow opening operates as a water outlet port for the water, such that the second water flow opening is connected to an upstream portion of the water recirculation circuit and receives water flow therefrom, while the first water flow opening is connected to a downstream portion of the water recirculation circuit and delivers water flow thereto.

According to a second aspect of the presently disclosed subject matter there is provided a chlorinator, comprising the housing as defined herein regarding the first aspect of the presently disclosed subject matter, and an electrode assembly accommodated in the electrolysis chamber.

For example, the chlorinator comprises a control unit for controlling operation of the electrode assembly.

Additionally or alternatively, for example, the chlorinator comprises a fluid flow sensor arrangement configured for detecting the presence of water flowing inside the housing.

According to a third aspect of the presently disclosed subject matter there is provided a water recirculation circuit including:
at least one chlorinator as defined as defined herein regarding the second aspect of the presently disclosed subject matter;
a body of water;
a pumping system;
a controller;
an inlet conduit configured for channeling water from the body of water to the chlorinator;
an outlet conduit configured for channeling water from the chlorinator to the body of water.

For example, the chlorinator is installed in a first installation configuration, wherein the first water flow opening is connected to said inlet conduit such as to receive water flow therefrom, and wherein the second water flow opening is connected to said outlet conduit such as to deliver water flow thereto, during operation of the chlorinator. Alternatively, for example, the chlorinator is installed in a second installation configuration, wherein the second water flow opening is connected to said inlet conduit such as to receive water flow therefrom, and wherein the first water flow opening is connected to said outlet conduit such as to deliver water flow thereto, during operation of the chlorinator.

According to a fourth aspect of the presently disclosed subject matter there is provided a housing for use in a chlorinator, the chlorinator being operable with an electrode assembly accommodated in the housing to produce one or more sanitizing agents from solute dissolved in water in operation of the chlorinator, said housing to comprising a first water flow opening, a second water flow opening, an electrolysis chamber, a sampling chamber, and a flow stream separator:
the first water flow opening being axially spaced from the second water flow opening and defining therebetween a housing internal volume, the first water flow opening and the second water flow opening configured for being coupled to a source of water in operation of the chlorinator;
said electrolysis chamber being configured for accommodating therein at least a portion of the electrode assembly;
the electrolysis chamber axially extending between a first electrolysis chamber axial end and a second electrolysis chamber axial end, the first electrolysis chamber axial end being in fluid communication with the first water flow opening, the second electrolysis chamber axial end being in fluid communication with the second water flow opening;
the sampling chamber configured for selectively enabling sampling of water entering the housing in operation of the chlorinator;
the flow stream separator comprising a first partition edge, a second partition edge and a partition wall, the first partition edge being axially spaced from the second partition, the partition wall axially extending between the first partition edge and the second partition edge;
the partition wall separating the housing internal volume into a main channel and an auxiliary channel, the main channel extending axially between said first partition edge and said second partition edge, and axially wholly accommodating therein (in particular along a part of a length thereof) the electrolysis chamber on a first side of the partition wall, the auxiliary channel defined between and extending axially between a first auxiliary channel opening axially defined at the first partition edge and a second auxiliary channel opening axially defined at the second partition edge, the sampling chamber being wholly accommodated axially in the auxiliary channel between the first auxiliary channel opening and the second auxiliary channel opening, on a second side of the partition wall;
the flow separator being configured in operation of the chlorinator for separating at the first partition edge water flowing into the housing via the first water flow opening into a main water stream flowing through the main channel and an auxiliary water stream flowing through the auxiliary channel between the first partition edge and the second partition edge (or between the first auxiliary channel opening and the second auxiliary channel opening).

For example, the sampling chamber comprises at least one sampling port, configured for enabling at least one sensor to be introduced into the sampling chamber from an outside of the housing.

For example, the partition wall is configured for preventing any transverse cross-flow between the main channel and the auxiliary channel, at any location between the first partition edge and the second partition edge.

For example, the first partition edge is axially spaced from the first electrolysis chamber axial end of the electrolysis chamber. Additionally or alternatively, for example, the second partition edge is axially spaced from the second electrolysis chamber axial end of the electrolysis chamber.

For example, the flow separator is further configured in operation of the chlorinator for separating at the second partition edge water flowing into the housing via the second water flow opening into a respective main water stream flowing through the main channel and a respective auxiliary stream flowing through the auxiliary channel.

Additionally or alternatively, for example, the partition wall transversely separates the housing internal volume into the main channel and the auxiliary channel

Additionally or alternatively, for example, the main channel wholly accommodates therein the electrolysis chamber on a first transverse side of the partition wall.

Additionally or alternatively, for example, the auxiliary channel wholly accommodates therein the sampling chamber on a second transverse side of the partition wall, the second transverse side being opposite facing with respect to the first transverse side.

Additionally or alternatively, for example, the partition wall is impermeable to water.

Additionally or alternatively, for example, the first partition edge is spaced from the first water flow opening by a first axial spacing.

Additionally or alternatively, for example, the second partition edge is spaced from the second water flow opening by a second axial spacing.

Additionally or alternatively, for example, said first partition edge has an axially extending cross-section parallel to a centerline of the housing.

Additionally or alternatively, for example, said second partition edge has an axially extending cross-section parallel to a centerline of the housing.

Additionally or alternatively, for example, said partition wall has a shielding wall axial cross-section parallel to a centerline of the housing.

Additionally or alternatively, for example, said first partition edge defines a first auxiliary channel opening having a first auxiliary channel transverse cross-sectional area, and a first main channel opening having a first main channel transverse cross-sectional area. For example, a ratio of said first main channel transverse cross-sectional area to said first auxiliary channel transverse cross-sectional area is in the range between about 7 to 20 about 15. For example, a ratio of said first main channel transverse cross-sectional area to said first auxiliary channel transverse cross-sectional area is any one of: 15, 14, 13, 12, 11, 10, 9, 8, 7.

Additionally or alternatively, for example, said second partition edge defines a second auxiliary channel opening having a second auxiliary channel transverse cross-sectional area, and a second main channel opening having a second main channel transverse cross-sectional area. For example, a ratio of said second main channel transverse cross-sectional area to said second auxiliary channel transverse cross-sectional area is in the range between about 7 to about 15. For example, a ratio of said second main channel transverse cross-sectional area to said second auxiliary channel transverse cross-sectional area is any one of: 15, 14, 13, 12, 11, 10, 9, 8, 7.

Additionally or alternatively, for example, the first electrolysis chamber axial end is axially spaced with respect to the first water flow opening by a third axial spacing, and wherein the second electrolysis chamber axial end is axially spaced with respect to the second water flow opening a fourth axial spacing. For example, a ratio of said first axial spacing to said third axial spacing is in any one of the following ranges: 0.2 to 0.8; 0.5 to 0.7; 0.2 to 0.5. For example, a ratio of said second axial spacing to said fourth axial spacing is in any one of the following ranges: 0.2 to 0.8; 0.5 to 0.7; 0.2 to 0.5.

Additionally or alternatively, for example, said sampling chamber comprises a flow diverter configured for directing the auxiliary water stream from the first axial edge to a bottom section of the sampling chamber, and for directing the auxiliary water stream from said bottom section to the second axial edge, the flow diverter including a barrier wall in the sampling chamber and projecting transversely in the auxiliary channel with respect to a longitudinal axis of the housing. For example, said flow diverter is configured for causing the auxiliary water stream to change direction by an angle greater than 60° degrees when flowing through the auxiliary channel from the first axial edge to the bottom section. Additionally or alternatively, for example, said barrier wall transversely projecting away from the second side of the partition wall. Additionally or alternatively, for example, the sampling chamber including the flow diverter are configured for providing a water trap in operation of the respective chlorinator.

Additionally or alternatively, for example, said sampling chamber comprises at least one, and for example a plurality of, said sampling ports, each said port configured for enabling a sensor to be introduced into the sampling chamber from an outside of the housing.

Additionally or alternatively, for example, the sampling chamber is laterally displaced with respect to the electrolysis chamber.

Additionally or alternatively, for example, the sampling chamber comprises a laterally disposed access hatch.
Additionally or alternatively, for example, the housing is configured for being

coupled to an inlet conduit and to an outlet conduit of a water recirculation circuit, alternately in each one of a first installation configuration and a second installation configuration, wherein:
in said first installation configuration the first water flow opening operates as a water inlet port and the second water flow opening operates as a water outlet port for the water, such that the first water flow opening is connected to an upstream portion of the water recirculation circuit and receives water flow therefrom, while the second water flow opening is connected to a downstream portion of the water recirculation circuit and delivers water flow thereto;

in second first installation configuration the second water flow opening operates as a water inlet port and the first water flow opening operates as a water outlet port for the water, such that the second water flow opening is connected to an upstream portion of the water recirculation circuit and receives water flow therefrom, while the first water flow opening is connected to a downstream portion of the water recirculation circuit and delivers water flow thereto.

Additionally or alternatively, for example, the housing comprises at least one acid port and a sampling chamber shielding arrangement as defined herein regarding the first aspect of the presently disclosed subject matter. For example, the flow separator is configured as a shielding arrangement, for example as defined herein regarding the first aspect of the presently disclosed subject matter.

For example, the housing comprises further comprising at least one acid entry port, wherein:
the at least one acid entry port is configured for selectively enabling introduction of an acid transversely therethrough into the electrolysis chamber;
the flow stream separator being transversely interposed between the at least one acid entry port and the sampling chamber;
the flow stream separator being configured for preventing transverse fluid communication therethrough.

For example, the at least one acid port is wholly located in said main channel.

Additionally or alternatively, for example, the at least one acid entry port is axially intermediate with respect to the first partition edge and the second partition edge.

Additionally or alternatively, for example, the at least one acid entry port is transversely spaced from the partition wall by a first vertical spacing. For example, the partition wall has a partition wall axial length, and wherein a ratio of the first vertical spacing to the partition wall axial length is between 0.05 to 0.15.

Additionally or alternatively, for example, the first partition edge extends away from the at least one acid entry port towards the first water flow opening by a first axial distance. For example, said first axial distance is about 30% of an axial dimension of the housing.

Additionally or alternatively, for example, the second partition edge extends away from the at least one acid entry port and towards the second water flow opening by a second axial distance. For example, said second axial distance is about 30% of an axial dimension of the housing,

Additionally or alternatively, for example, the housing comprises a single said acid entry port.

According to the fourth aspect of the presently disclosed subject matter there is also provided a chlorinator including an electrode assembly and a housing. The housing includes a first water flow opening, a second water flow opening, an electrolysis chamber for accommodating the electrode assembly, a sampling chamber for selectively enabling sampling of water entering the housing in operation of the chlorinator, and a flow stream separator. The flow stream separator includes a partition wall axially extending between a first partition edge and a second partition edge. The partition wall separates the housing internal volume into a main channel and an auxiliary channel. The main channel extends axially between the first partition edge and the second partition edge, and wholly accommodates therein the electrolysis chamber on a first side of the partition wall. The auxiliary channel extends axially between the first partition edge and the second partition edge and wholly accommodates therein the sampling chamber on a second side of the partition wall. The flow separator separates water flowing into the housing into a main water stream flowing through the main channel, and thus through the electrode assembly, and an auxiliary water stream flowing through the auxiliary channel, and thus through the sampling chamber.

According to a fifth aspect of the presently disclosed subject matter, there is provided a chlorinator, comprising the housing as defined herein regarding the fourth aspect of the presently disclosed subject matter, and an electrode assembly accommodated in the electrolysis chamber.

For example, the chlorinator comprises a control unit for controlling operation of the electrode assembly.

Additionally or alternatively, for example, the chlorinator comprises a fluid flow sensor arrangement configured for detecting the presence of water flowing inside the housing.

According to a sixth aspect of the presently disclosed subject matter there is provided a water recirculation circuit including:
at least one chlorinator as defined herein according to the fifth aspect of the presently disclosed subject matter;
a body of water;
a pumping system;
a controller;
an inlet conduit configured for channeling water from the body of water to the chlorinator;
an outlet conduit configured for channeling water from the chlorinator to the body of water.

For example, the chlorinator is installed in a first installation configuration, wherein the first water flow opening is connected to said inlet conduit such as to receive water flow therefrom, and wherein the second water flow opening is connected to said outlet conduit such as to deliver water flow thereto, during operation of the chlorinator.

For example, the chlorinator is installed in a second installation configuration, wherein the second water flow opening is connected to said inlet conduit such as to receive water flow therefrom, and wherein the first water flow opening is connected to said outlet conduit such as to deliver water flow thereto, during operation of the chlorinator.

According to a seventh aspect of the presently disclosed subject matter there is provided a housing for use in a chlorinator, the chlorinator being operable with an electrode assembly accommodated in the housing to produce one or more sanitizing agents from solute dissolved in water in operation of the chlorinator, said housing comprising a first water flow opening, a second water flow opening, an electrolysis chamber, a sampling chamber:
the first water flow opening being axially spaced from the second water flow opening and defining therebetween a housing internal volume, the first water flow opening and the second water flow opening configured for being coupled to a source of water in operation of the chlorinator;
said electrolysis chamber being configured for accommodating therein at least a portion of the electrode assembly;
the housing being configured in operation of the chlorinator for separating water flowing into the housing via the first water flow opening into a main water stream flowing through a main channel and an auxiliary water stream flowing through an auxiliary channel;
the sampling chamber comprising a flow diverter, the flow diverter including a barrier wall in the sampling chamber and projecting transversely in the auxiliary channel with respect to a longitudinal axis of the housing, the flow diverter configured for directing the auxiliary water stream from a first end of the auxiliary channel to a bottom section of the sampling chamber, and for directing the auxiliary water stream from said bottom section to a second end of the auxiliary channel.

For example, the sampling chamber comprises at least one sampling port, configured for enabling at least one sensor to be introduced into the sampling chamber from an outside of the housing.

For example, said flow diverter is configured for causing the auxiliary water stream to change direction by an angle greater than 60° degrees when flowing through the auxiliary channel from the first end to the bottom section.

Additionally or alternatively, for example, said housing further comprises a sampling chamber shielding arrangement including an axially extending shielding wall, wherein said barrier wall transversely projects away from one side of the shielding wall.

Additionally or alternatively, for example, the shielding arrangement is configured for preventing any transverse cross-flow between the main channel and the auxiliary channel, at any location between the first axial edge and the second axial edge.

Additionally or alternatively, for example, the sampling chamber including the flow diverter are configured for providing a water trap in operation of the respective chlorinator.

Additionally or alternatively, for example, the housing comprises a flow separator as defined herein regarding the fourth aspect of the presently disclosed subject matter.

Additionally or alternatively, for example, the housing comprises at least one acid port and a sampling chamber shielding arrangement as defined herein regarding the first aspect of the presently disclosed subject matter. For example the sampling chamber shielding arrangement comprises a shielding wall having a first side and a second side, wherein the electrolysis chamber is on the first side of the sampling chamber shielding arrangement. For example, said barrier wall is transversely projecting away from a second side of the shielding wall.

According to an eighth aspect of the presently disclosed subject matter, there is provided a chlorinator, comprising the housing as defined herein regarding the seventh aspect of the presently disclosed subject matter, and an electrode assembly accommodated in the electrolysis chamber.

For example, the chlorinator comprises a control unit for controlling operation of the electrode assembly.

Additionally or alternatively, for example, the chlorinator comprises a fluid flow sensor arrangement configured for detecting the presence of water flowing inside the housing.

According to a ninth aspect of the presently disclosed subject matter there is provided a water recirculation circuit including:
at least one chlorinator as defined herein according to the eighth aspect of the presently disclosed subject matter;
a body of water;
a pumping system;
a controller;
an inlet conduit configured for channeling water from the body of water to the chlorinator;
an outlet conduit configured for channeling water from the chlorinator to the body of water.

For example, the chlorinator is installed in a first installation configuration, wherein the first water flow opening is connected to said inlet conduit such as to receive water flow therefrom, and wherein the second water flow opening is connected to said outlet conduit such as to deliver water flow thereto, during operation of the chlorinator.

For example, the chlorinator is installed in a second installation configuration, wherein the second water flow opening is connected to said inlet conduit such as to receive water flow therefrom, and wherein the first water flow opening is connected to said outlet conduit such as to deliver water flow thereto, during operation of the chlorinator.

According to a tenth aspect of the presently disclosed subject matter there is provided a housing for use in a chlorinator, the chlorinator being operable with an electrode assembly accommodated in the housing to produce one or more sanitizing agents from solute dissolved in water in operation of the chlorinator, said housing comprising a first water flow opening, a second water flow opening, an electrolysis chamber, a sampling chamber, at least one acid entry port, and a sampling chamber shielding arrangement:
the first water flow opening being axially spaced from the second water flow opening and defining therebetween a housing internal volume, the first water flow opening and the second water flow opening configured for being coupled to a source of water in operation of the chlorinator;
said electrolysis chamber being configured for accommodating therein at least a portion of the electrode assembly;
the housing being configured in operation of the chlorinator for separating water flowing into the housing via the first water flow opening into a main water stream flowing through a main channel and an auxiliary water stream flowing through an auxiliary channel;
the sampling chamber configured for providing a water trap in operation of the respective chlorinator.

For example, the sampling chamber comprises a flow diverter configured for directing the auxiliary water stream from a first end of the auxiliary channel to a bottom section of the sampling chamber, and for directing the auxiliary water stream from said bottom section to a second end of the auxiliary channel.

For example, said flow diverter is configured for causing the auxiliary water stream to change direction by an angle greater than 60° degrees when flowing through the auxiliary channel from the first end to the bottom section.

Additionally or alternatively, for example, said flow diverter is in the form of a barrier wall in the sampling chamber, said barrier wall transversely projecting away from the second side of the shielding wall.

Additionally or alternatively, for example, the housing comprises a flow separator as defined herein regarding the fourth aspect of the presently disclosed subject matter.

Additionally or alternatively, for example, the housing comprises at least one acid port and a sampling chamber shielding arrangement as defined herein regarding the first aspect of the presently disclosed subject matter.

According to an eleventh aspect of the presently disclosed subject matter, there is provided a chlorinator, comprising the housing as defined herein regarding the tenth aspect of the presently disclosed subject matter, and an electrode assembly accommodated in the electrolysis chamber.

For example, the chlorinator comprises a control unit for controlling operation of the electrode assembly.

Additionally or alternatively, for example, the chlorinator comprises a fluid flow sensor arrangement configured for detecting the presence of water flowing inside the housing.

According to a twelfth aspect of the presently disclosed subject matter there is provided a water recirculation circuit including:
at least one chlorinator as defined herein according to the eleventh aspect of the presently disclosed subject matter;
a body of water;
a pumping system;
a controller;
an inlet conduit configured for channeling water from the body of water to the chlorinator;
an outlet conduit configured for channeling water from the chlorinator to the body of water.

For example, the chlorinator is installed in a first installation configuration, wherein the first water flow opening is connected to said inlet conduit such as to receive water flow therefrom, and wherein the second water flow opening is connected to said outlet conduit such as to deliver water flow thereto, during operation of the chlorinator.

For example, the chlorinator is installed in a second installation configuration, wherein the second water flow opening is connected to said inlet conduit such as to receive water flow therefrom, and wherein the first water flow opening is connected to said outlet conduit such as to deliver water flow thereto, during operation of the chlorinator.

### BRIEF DESCRIPTION OF THE DRAWINGS

In order to better understand the subject matter that is disclosed herein and to exemplify how it may be carried out in practice, examples will now be described, by way of non-limiting example only, with reference to the accompanying drawings, in which:

FIG. 1 is an isometric front-top-side view of a chlorinator according to an example of the presently disclosed subject matter.

FIG. 2 is a front view of the example of FIG. 1; FIG. 2(a) is a front view of the example of FIG. 2 in which the sampling chamber outer cover is removed.

FIG. 3 is a side view of the example of FIG. 1.

FIG. 4 is a top view of the example of FIG. 1.

FIG. 5 is an isometric rear-top-side cross-sectional view of the housing of the

example of FIG. 1, taken about section A-A of FIG. 2.

FIG. 6 is an isometric front-top-side cross-sectional view of the example of FIG. 1, taken about section A-A of FIG. 2.

FIG. 7 is an isometric rear-top-side cross-sectional view of the housing of the example of FIG. 1, taken about section B-B of FIG. 3.

FIG. 8 is an isometric rear-top-side view of an example of the electrode assembly of the example of FIG. 1.

FIG. 9 is an isometric rear-top-side exploded view of an example of the electrode assembly of the example of FIG. 8.

FIG. 10 is an isometric front-top-side cross-sectional view of the example of FIG. 1, taken about section C-C of FIG. 3.

FIG. 11 is an isometric front-top-side cross-sectional view of the example of FIG. 1, taken about section D-D of FIG. 3.

FIG. 12(a) is one side view of the example of FIG. 1; FIG. 12(b) is the opposite side view of the example of FIG. 12(a).

FIG. 13 is a top cross-sectional view of the example of FIG. 1, taken about section E-E of FIG. 3.

FIG. 14 is an isometric rear-top-side cross-sectional view of the example of FIG. 1, taken about section F-F of FIG. 3.

FIG. 15 is an isometric front-top-side exploded view of an example of FIG. 1; FIG. 15(a) is an isometric rear-top-side the sampling chamber outer cover including sensor probes of the example of FIG. 15.

FIG. 16 is a side cross-sectional view of the example of FIG. 1, taken about section G-G of FIG. 2.

FIG. 17 is an isometric rear-top cross-sectional view of the housing of the example of FIG. 1, taken about section B-B of FIG. 3.

FIG. 18 is an isometric rear-top-side cross-sectional view of the housing of an alternative variation of the example of FIG. 7.

FIG. 19 is a side view of the housing of an alternative variation of the example of FIG. 12(b).

FIG. 20(a) is a schematic illustration of a recirculation circuit including the example of FIG. 1 installed in a first installation configuration; FIG. 20(b) is a schematic illustration of a recirculation circuit including the example of FIG. 1 installed in a second installation configuration.

### DETAILED DESCRIPTION

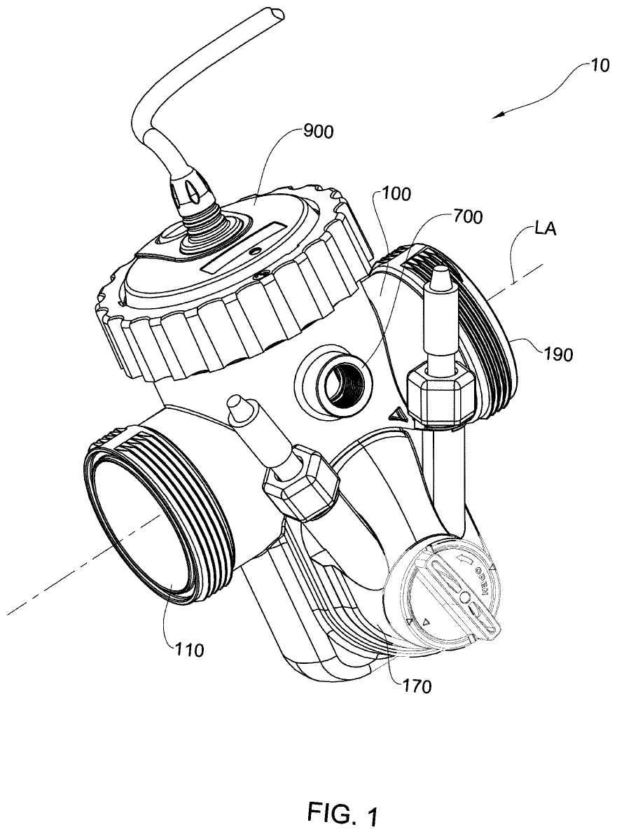

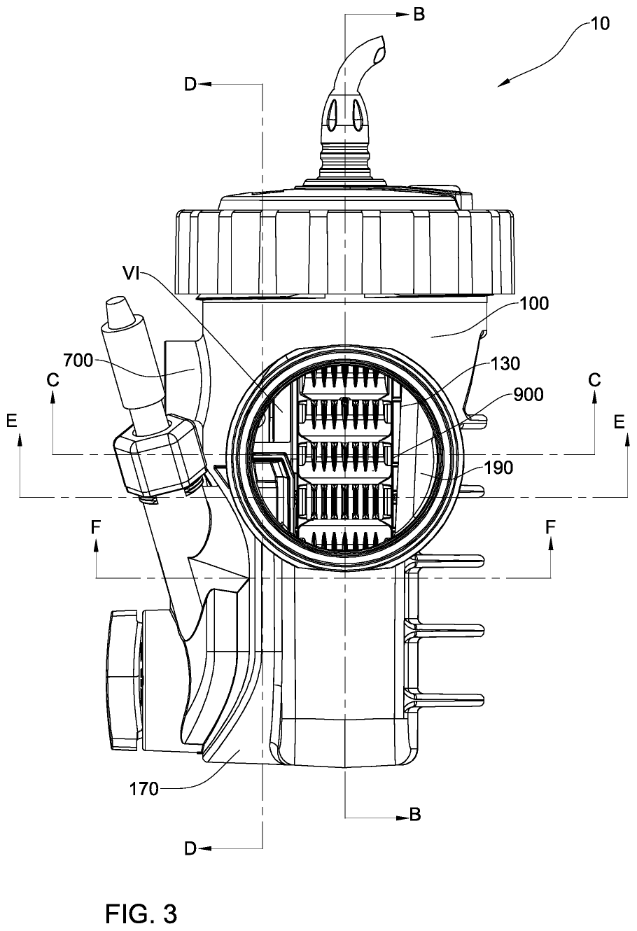

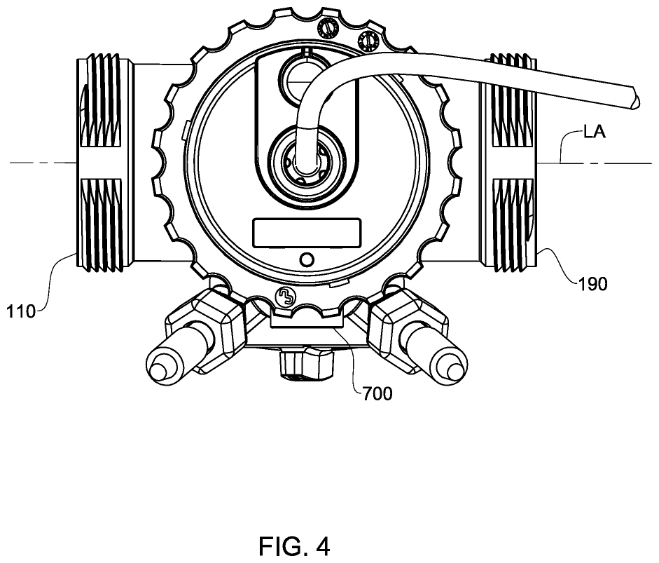

Referring to FIGS. 1, 2, 3, 4, a chlorinator (also referred to herein interchangeably as a pool chlorinator) according to a first example of the presently disclosed subject matter, generally designated with reference numeral 10, comprises a housing 100 and an electrode assembly 900.

The chlorinator 10 is configured for utilizing electrolysis to produce sanitizing agents from a solute, for example to be supplied to a body of water, for example a swimming pool. For example, the chlorinator 10 can be a salt-water chlorinator, configured to electrolyze salt (NaCl) dissolved in water to produce hypochlorous acid and sodium hypochlorite, as is well known in the art.

Thus, while the chlorinator 10 can be used for sanitizing pool water and thus for use with a pool or the like, it can also be used for providing sanitizing agents to any suitable body of water.

As will become clearer herein, the pool chlorinator 10 is operable, with the electrode assembly 900 accommodated in the housing 100, to produce one or more sanitizing agents from solute dissolved in water in operation of the chlorinator 10.

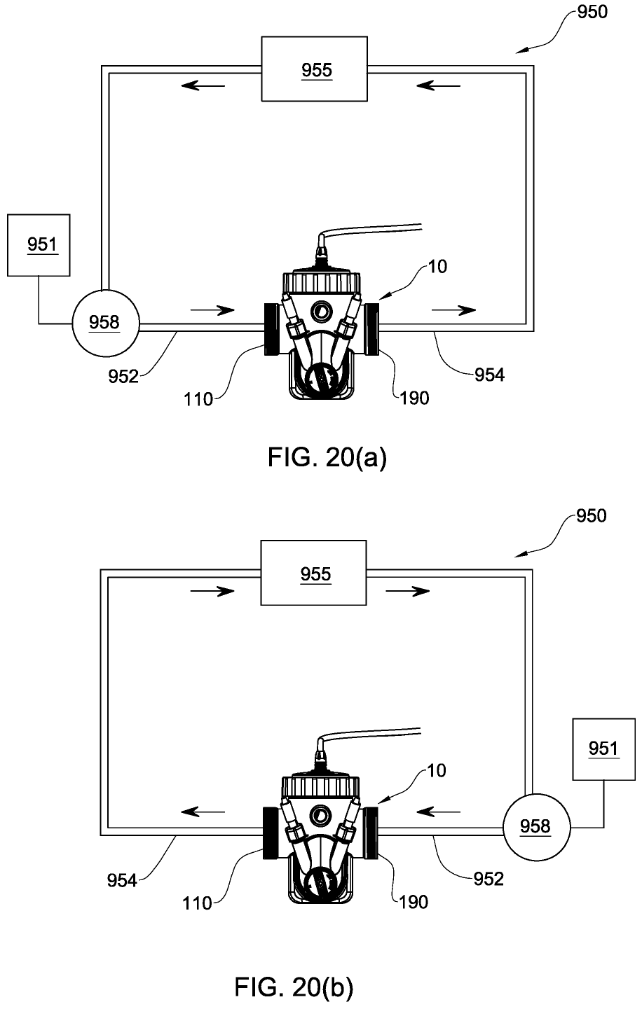

Referring to FIG. 20(a) and FIG. 20(b), the chlorinator 10 can be part of a water recirculation circuit 950, which thus comprises the pool chlorinator 10 and inter alia a pool 955 or other suitable body of water, a pumping system 958, controller 951, and inlet conduit 952 and outlet conduit 954.

In alternative variations of this example, the respective water recirculation circuit can include a plurality of pool chlorinators, for example a plurality of pool chlorinators 10, which can be coupled to the inlet circuit and outlet conduit in series and/or in parallel.

The housing 100, which is per se novel, is thus configured for use with respect to the chlorinator 10.

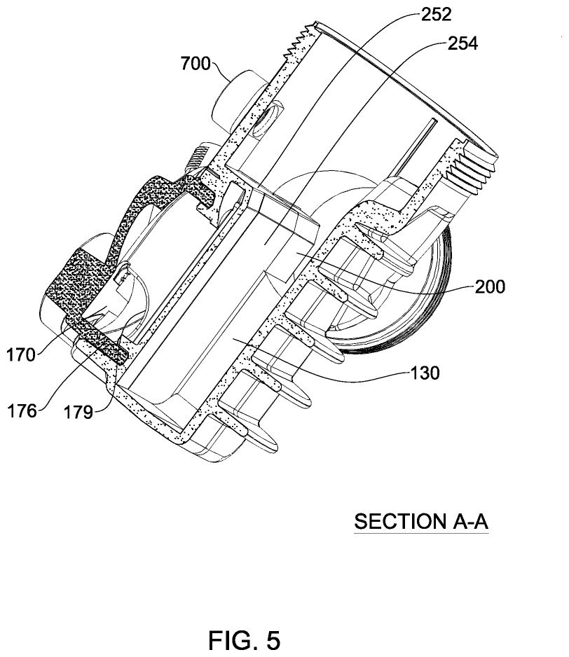

Referring also to FIGS. 5, 6, 7, the housing 100 comprises a first water flow opening 110, a second water flow opening 190, an electrolysis chamber 130, a sampling chamber 170, and a flow stream separator 200.

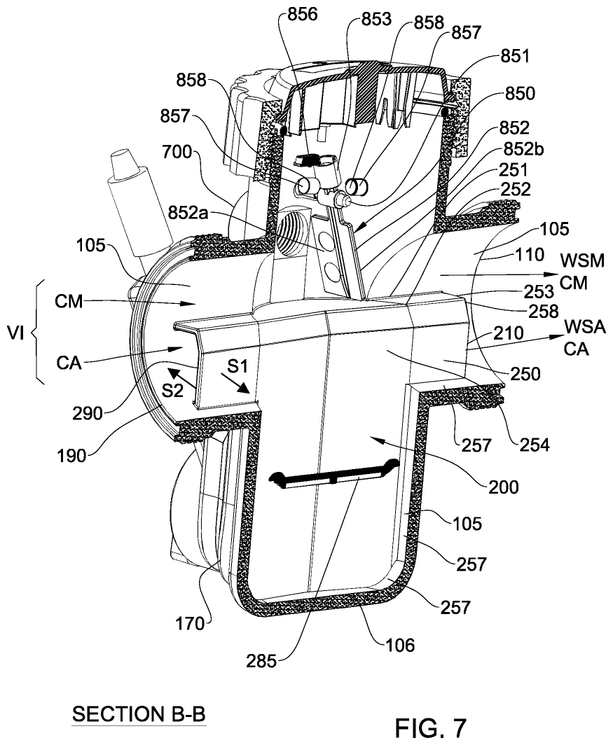

The first water flow opening 110 is axially spaced from the second water flow opening 190. Referring in particular to FIG. 7, the housing 100 defines a housing internal volume VI axially extending between the first water flow opening 110 and the second water flow opening 190.

A longitudinal axis LA (also referred to herein as the centerline) for the housing 100 can be defined extending between the first water flow opening 110 and the second water flow opening 190, for example passing through the respective centers of the first water flow opening 110 and the second water flow opening 190.

Herein, and unless otherwise stated, “axially” refers a direction parallel to or co-axial with the longitudinal axis LA, while “transverse”, “transversely” and so on refer to a direction nominally orthogonal (or at least partially orthogonal) to the longitudinal axis LA.

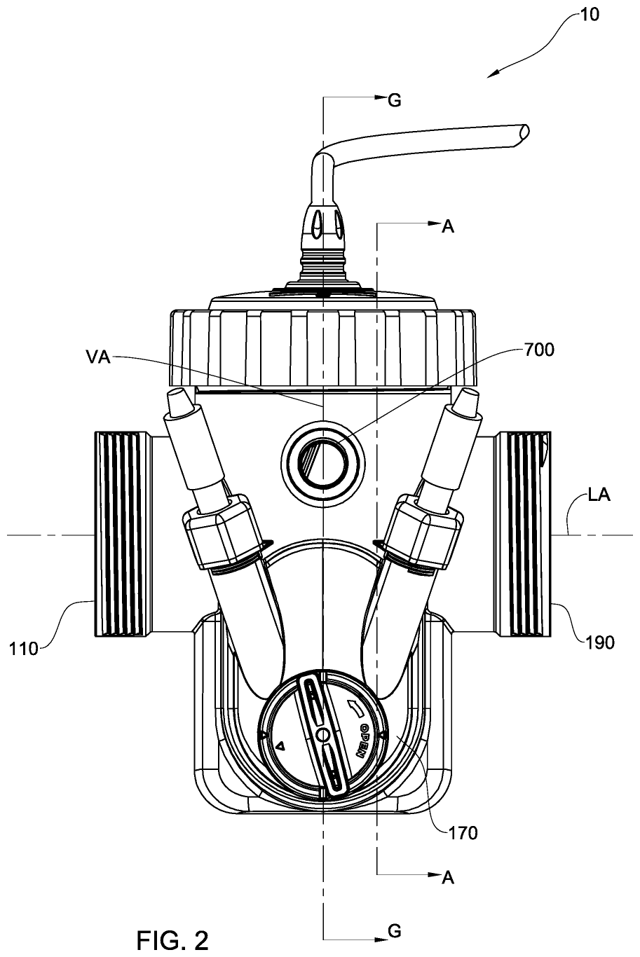

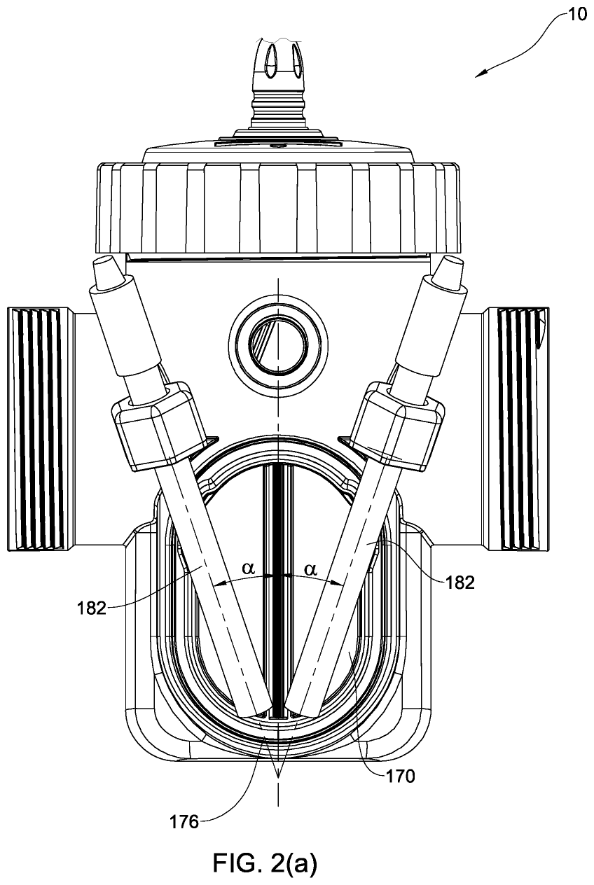

A vertical axis VA (FIG. 2) can be defined orthogonal to the longitudinal axis LA, in the vertical direction for example with respect to the view of FIG. 2

The first water flow opening 110 and the second water flow opening 190 are each configured for being coupled to a source of water, for example a source of pool water, for example a pool 955 or other suitable body of water (FIGS. 20(a), 20(b)) in operation of the chlorinator 10, for example via the recirculation circuit 950.

In at least this example, the housing 100 is configured for enabling the chlorinator 10 to be connected to the recirculation circuit 950 in each one of at least two installation configurations, including a first installation configuration and a second installation configuration. This feature can allow flexibility of installation of the pool chlorinator 10 with respect to different configurations of the recirculation circuit 950.

In the first installation configuration, and referring again to FIG. 20(a), the chlorinator 10 can be connected to the recirculation circuit 950 such that the first water flow opening 110 operates as a water inlet port and the second water flow opening 190 as a water outlet port for the water. Thus the first water flow opening 110 is connected to an upstream portion of the water recirculation circuit 950, i.e., the inlet conduit 952, and receives water flow therefrom, while the second water flow opening 190 is connected to a downstream portion of the water recirculation circuit 950, i.e., outlet conduit 954, and delivers water flow thereto.

In the second installation configuration, and referring to FIG. 20(b), the chlorinator 10 can be connected to the recirculation circuit 950 such that the second water flow opening 190 operates as a water inlet port and the first water flow opening 110 as a water outlet port for the water. Thus the second water flow opening 190 is connected to an upstream portion of the water recirculation circuit 950, i.e., inlet conduit 952, and receives water flow therefrom, while the first water flow opening 110 is connected to a downstream portion of the water recirculation circuit 950, i.e., outlet conduit 954, and delivers water flow thereto.

In operation of the chlorinator 10, water from the recirculation circuit 950 flows into the internal volume VI, from the first water flow opening 110 to the second water flow opening 190 (first installation configuration), or from the second water flow opening 190 to the first water flow opening 110 (second installation configuration).

The electrolysis chamber 130 is configured for accommodating therein at least a portion of the electrode assembly 900.

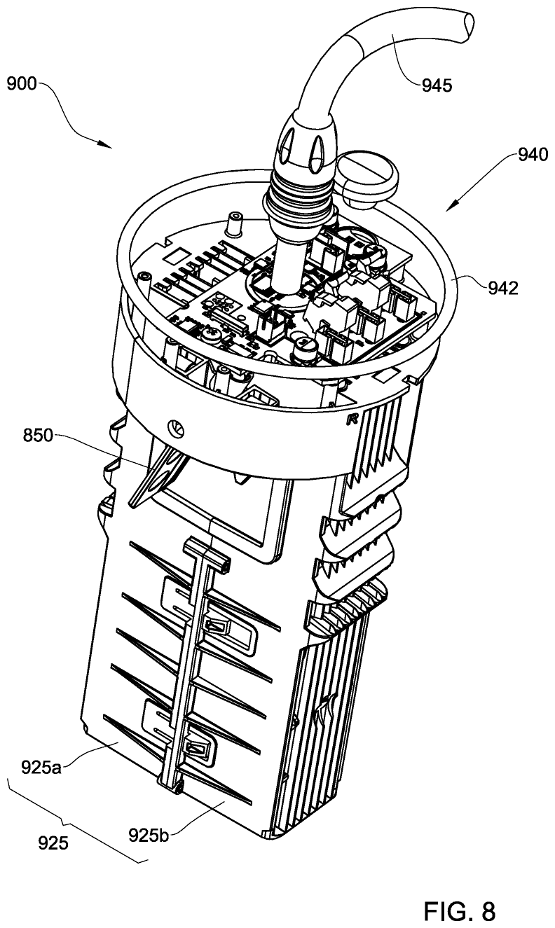

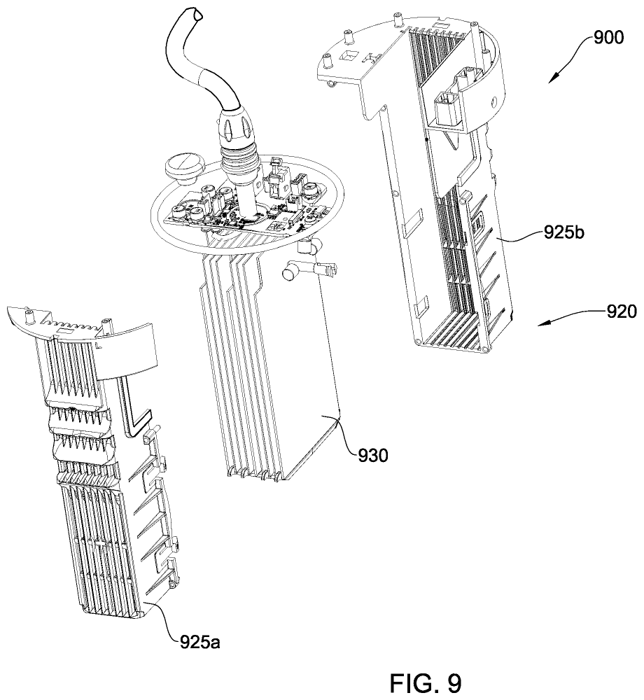

In at least this example, and referring also to FIGS. 8 and 9, the electrode assembly 900 comprises an electrolysis cassette 920, comprising a plurality of electrodes in the form of electrolysis plates 930 (also interchangeably referred to herein as electrodes), and a cassette case 925. The electrolysis plates 930 are held in adjacent laterally spaced and parallel spatial relationship with respect to one another via cassette case 925, defining axially and vertically extending lateral gaps between each pair of adjacent electrolysis plates 930, through which water flows during operation of the chlorinator 10. In at least this example, the cassette case 925 comprises a pair of cassette case halves 925a, 925b that interconnect together laterally to provide an internal volume for accommodating and aligning therein the electrolysis plates 930.

The electrode assembly 900 further comprises a control unit 940 configured for controlling and powering the electrolysis cassette 920, in electrical communication via cable 945 with an external electrical power source, and optionally also in electrical communication via cable 945 with an external controller that can form part of the water recirculation circuit 950.

The electrode assembly 900 further comprises a sealing member 942, such as for example a gasket or O-ring, provided to seal between the hosing internal volume VI and the control unit 940, and thus prevent ingress of water into the control unit 940 from inside the housing 100 during operation of the chlorinator 10.

In operation of the chlorinator 10, the electrolysis plates 930 are configured for providing electricity to the water within the electrolysis chamber 130 for electrolysis thereof, as controlled by the control unit 940, for example as described herein.

In at least this example, the control unit 940 is configured to direct operation of components of the chlorinator 10. For example, it can collect information from the electrode assembly 900, regulate power supply thereto (which can include, but is not limited to, one or more of determining the amount and/or polarity of electricity for supplying to the electrolysis cassette, requesting suitable power from the power supply, verifying power received, etc.), receive user commands, and provide information for display thereby.

Accordingly, the control unit 940 can comprise, for example, a printed circuit board, comprising one or more microcontrollers configured to facilitate the directing, as well as any suitable memory modules, sensors, output connectors, power connectors, etc., which may be necessary.

The control unit 940 can be further configured to monitor the internal temperature of the control unit 940, and to operate to lower the power output of the power supply in order to prevent damage to the control unit 940, without ceasing the electrolytic production of sanitizing agents (it will be appreciated that the power supply may be configured to perform this function without direction from the control unit 940, for example being provided with a suitable dedicated controller configured therefor).

It will be appreciated that while in at least this example, the control unit 940 as a single element, in alternative variations of this example, the control unit 940 can comprise a combination of elements, which are or which are not in physical proximity to one another, without departing from the scope of the presently disclosed subject matter.

The cassette case 925, in at least this example, defines an outer shape that is generally in the form of a rectangular cuboid form (right rectangular prism).

Correspondingly, and in at least this example, the electrolysis chamber 130 has a complementarily-shaped internal volume corresponding to shape of the portion of the electrode assembly 900 that is to be accommodated therein. In at least this example, the electrolysis chamber 130 is provided within the internal volume VI and is contiguous with other parts of the internal volume VI, without the need for dedicated physical internal walls to demarcate the electrolysis chamber 130 from the remainder of the internal volume VI.

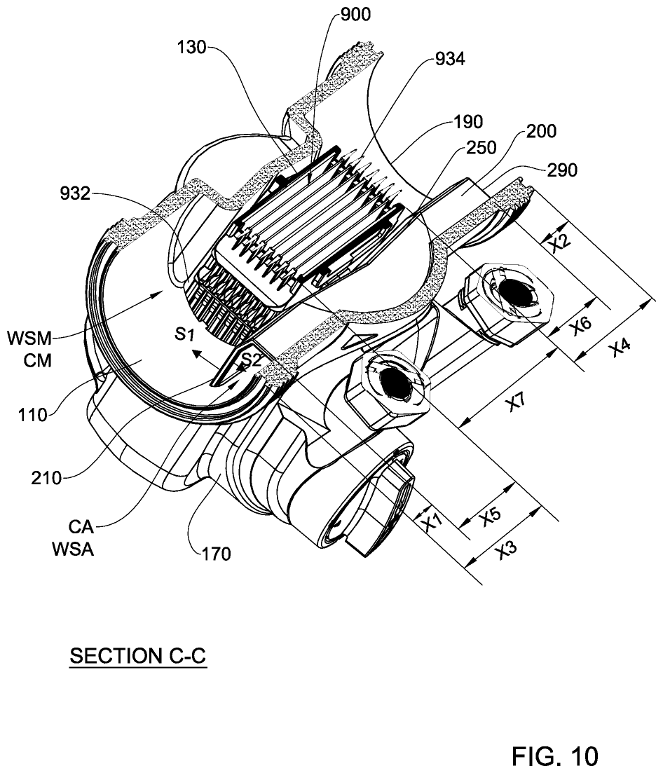

Nevertheless, and referring also to FIG. 10, the electrolysis chamber 130 can be considered to axially extend between a first electrolysis chamber axial end 932 and a second electrolysis chamber axial end 934, sufficient for accommodating therein an axial dimension of the electrode assembly 900, and in particular sufficient for accommodating an axial dimension of the portion of the electrolysis cassette 920 therein. The first electrolysis chamber axial end 932 is thus in free fluid communication with the first water flow opening 110, while the second electrolysis chamber axial end 934 is in free fluid communication with the second water flow opening 190.

Furthermore, in at least this example, the first electrolysis chamber axial end 932 is facing the first water flow opening 110, while the second electrolysis chamber axial end 934 is facing the second water flow opening 190.

As will become clearer herein, the sampling chamber 170 is configured for selectively enabling sampling of water entering the housing 900 in operation of the pool chlorinator 10.

According to an aspect of the presently disclosed subject matter, and referring in particular to FIG. 7, the flow stream separator 200 comprises a first partition edge 210, a second partition edge 290 and a partition wall 250, the partition wall 250 axially extending between the first partition edge 210 and the second partition edge 290.

In at least this example, the partition wall 250 is laterally and vertically offset with respect to the longitudinal axis LA.

The partition wall 250 is a water impermeable physical wall, in at least this example in the form of a solid wall, that separates at least a central portion of the housing internal volume VI into a main channel CM and an auxiliary channel CA.

The partition wall 250 is connected to an inner surface of the housing 100 in a sealed manner transversely, such as to prevent any cross-flow between the main channel CM and the auxiliary channel CA, at any location between first partition edge 210 and the second partition edge 290. Thus, the flow stream separator 200 is configured for preventing any transverse cross-flow between the main channel CM and the auxiliary channel CA, at any axial location between the first partition edge 210 and the second partition edge 290. Without being bound to theory, the inventors consider that prevention of any such potential cross-flow can prevent or minimize contamination of the auxiliary channel CA (and thus of the sampling chamber) from the main channel CM.

Referring in particular to FIGS. 7 and 10, the main channel CM extends axially between the first partition edge 210 and the second partition edge 290, and wholly accommodates therein, i.e., in an axial direction parallel to the longitudinal axis LA, the electrolysis chamber 130 on a first side S1 of the partition wall 250.

The auxiliary channel CA extends axially between the first partition edge 210 and the second partition edge 290 and wholly accommodates therein, i.e., in an axial direction parallel to the longitudinal axis LA, the sampling chamber 170 on a second side S2 of the partition wall 250.

The flow separator 200 is configured, in operation of the chlorinator 10, for separating at the first partition edge 210 water flowing into the housing 100 via the first water flow opening 110 into a main water stream WSM flowing through the main channel CM and an auxiliary water stream WSA flowing through the auxiliary channel CA, i.e., in the aforesaid first installation configuration.

Similarly, the flow separator 200 is further configured, in operation of the chlorinator, for separating at the second partition edge 290 water flowing into the housing 100 via the second water flow opening 190 into a respective main water stream WSM flowing through the main channel CM and a respective auxiliary water stream WSA flowing through the auxiliary channel CA, i.e., in the aforesaid second installation configuration.

In at least this example, the partition wall 250 transversely separates (with respect to the longitudinal axis LA) the internal volume VI into the main channel CM and the auxiliary channel CA. Thus, the main channel CM wholly accommodates therein the electrolysis chamber 130 on a first transverse side of the partition wall 250, while the auxiliary channel CA wholly accommodates therein the sampling chamber 170 on a second transverse side of the partition wall, the second transverse side being opposite facing with respect to the first transverse side.

Referring to FIG. 10, in at least this example the first partition edge 210 extends away from the first electrolysis chamber axial end 932 towards the first water flow opening 110. In at least this example the first partition edge 210 is spaced form the first water flow opening 110 by a first axial spacing X1.

Similarly, the second partition edge 290 extends away from the second electrolysis chamber axial end 934 and towards the second water flow opening 190. In at least this example the second partition edge 290 is spaced form the second water flow opening 190 by a second axial spacing X2.

In at least this example, the first axial spacing X1 is equal to the second axial spacing. Moreover, in at least this example, both the first axial spacing X1 and the second axial spacing X2 are non-zero.

However, it is to be noted that in at least some alternative variations of this example, only one of the first axial spacing X1 and the second axial spacing X2 can be non-zero, while the other one of the first axial spacing X1 and the second axial spacing X2 is zero. In yet other alternative variations of this example, the first axial spacing X1 and the second axial spacing X2 can be non-equal with respect to one another. In yet other alternative variations of this example, both the first axial spacing X1 and the second axial spacing X2 can be zero. In such cases where the first axial spacing X1 and/or the second axial spacing X2 can be zero, the respective the first partition edge 210 and/or the respective second partition edge 290 are each aligned with a respective plane defined at the outer edge of the respective first water flow opening 110 or the respective second water flow opening 190. In yet other alternative variations of this example, the first axial spacing X1 and/or the second axial spacing X2 can have a negative value, in which case the respective first partition edge 210 and/or the respective second partition edge 290 respectively project out of the housing 100 via the respective first water flow opening 110 or the respective second water flow opening 190; in such cases, the respective first partition edge 210 and/or the respective second partition edge 290 project into the respective portion of the conduits of the recirculation circuit 950, for example inlet conduit 952 or outlet conduit 954, that is connected to the first water flow opening 110 or the second water flow opening 190, respectively.

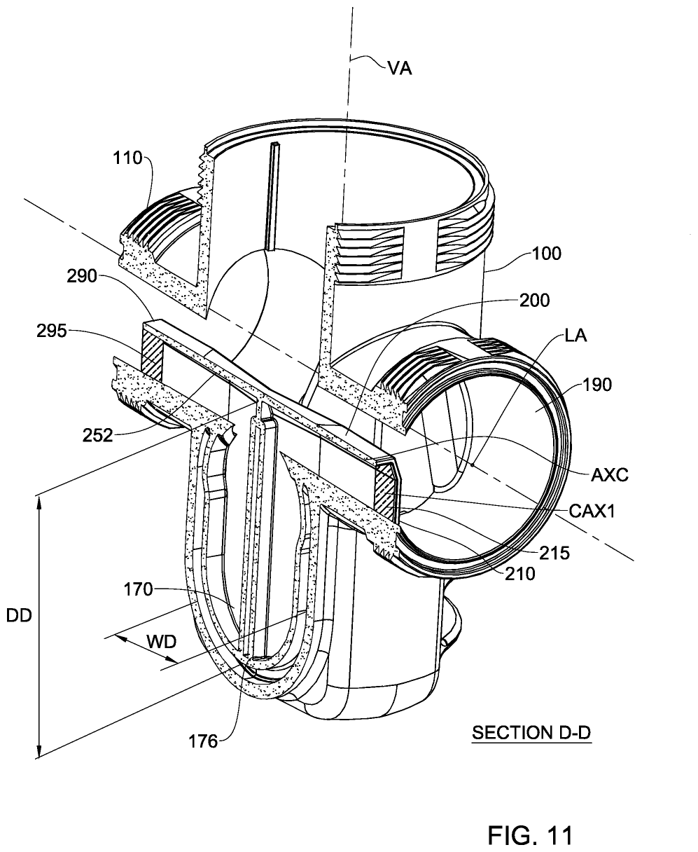

Referring in particular to FIG. 11, the partition wall 250 has a wall axial cross-section AXC parallel to a longitudinal axis LA of the housing 100.

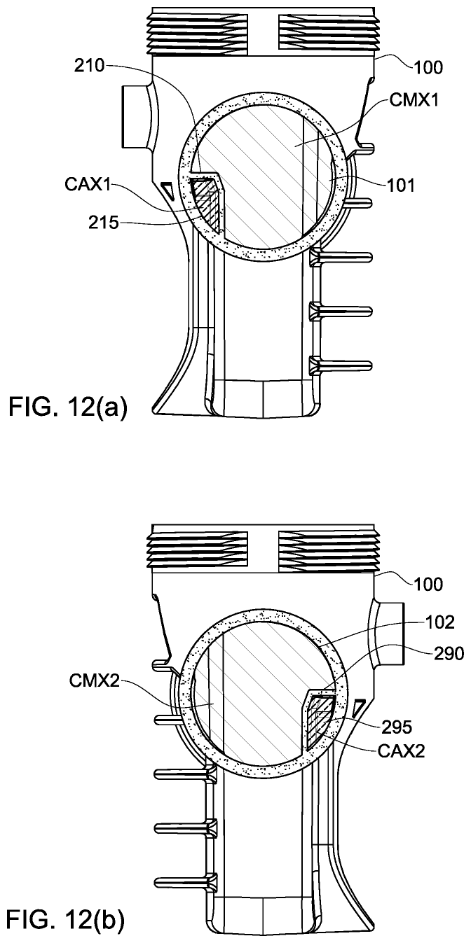

Furthermore, and referring in particular to FIG. 11 and FIG. 12(a), the first partition edge 210 defines a first auxiliary channel opening 215; in particular, the first partition edge 210 defines the location of the first auxiliary channel opening 215 in an axial manner. In at least this example, the first auxiliary channel opening 215 is defined orthogonal to the longitudinal axis LA and is at the axial location of the first partition edge 210.

In any case, the first auxiliary channel opening 215 has a first auxiliary channel transverse cross-sectional area CAX1, and a first main channel opening 101 having a first main channel transverse cross-sectional area CMX1. For example, the first auxiliary to channel transverse cross-sectional area CAX1 and the first main channel transverse cross-sectional area CMX1 can be taken along a plane orthogonal to the longitudinal axis LA at the axial location of the first partition edge 210. In at least one implementation of this example, the first auxiliary channel transverse cross-sectional area CAX1 can be about 3174 mm² and the first main channel transverse cross-sectional area CMX1 can be about 241 mm², and thus the respective ratio of said first main channel transverse cross-sectional area CMX1 to the first auxiliary channel transverse cross-sectional area CAX1 is about 13.2. In at least this or other examples, the respective ratio of the first main channel transverse cross-sectional area CMX1 to the first auxiliary channel transverse cross-sectional area CAX1 can be in the range between about 7 to about 15, for example any one of: 15, 14, 13, 12, 11, 10, 9, 8, 7.

Referring in particular to FIG. 11 and FIG. 12(b), the second partition edge 290 defines a second auxiliary channel opening 295; in particular, the second partition edge 290 defines the location of the second auxiliary channel opening 295 in an axial manner. In at least this example, the second auxiliary channel opening 295 is defined orthogonal to the longitudinal axis LA and is at the axial location of the second partition edge 290.

In any case, the second auxiliary channel opening 295 has a second auxiliary channel transverse cross-sectional area CAX2, and a second main channel opening 102 having a second main channel transverse cross-sectional area CMX2. For example, the second auxiliary channel transverse cross-sectional area CAX2 and the second main channel transverse cross-sectional area CMX2 can be taken along a plane orthogonal to the longitudinal axis LA at the axial location of the second partition edge 290. In at least one implementation of this example, the second auxiliary channel transverse cross-sectional area CAX2 can be about 3174mm 2 and the second main channel transverse cross-sectional area CMX2 can be about 241 mm², and thus the respective ratio of said second main channel transverse cross-sectional area CMX2 to the second auxiliary channel transverse cross-sectional area CAX2 is about 13.2. In at least this or other examples, the respective ratio of the second main channel transverse cross-sectional area CMX2 to the second auxiliary channel transverse cross-sectional area CAX2 can be in the range between about 7 to about 15, for example any one of: 15, 14, 13, 12, 11, 10, 9, 8, 7.

As best seen in FIG. 7, the partition wall 250 in at least this example has an inverted L-shaped axial cross-sectional shape, including a first partition wall portion 252 and a second partition wall portion 254. However, in alternative variations of this example, the partition wall 250 can have any suitable cross-section shape that prevents lateral flow between the main channel CM and the auxiliary channel CA in a vertical direction (parallel to the vertical axis VA) and also in a horizontal direction (for example orthogonal to the vertical axis VA and to the longitudinal axis LA); for example, the partition wall in such examples can have an inverted J-shaped axial cross-sectional shape—for example the first partition edge 210 and the second partition edge can each be arcuate in cross-section.

In at least this example, the first partition wall portion 252 extends axially between the first partition edge 210 and the second partition edge 290, and comprises a first lateral edge 251 fixedly connected to an upper portion of the internal wall surface 105 of the housing 100, and a second lateral edge 253 fixedly joined to the second partition wall portion 254. The first wall portion 252 essentially prevents lateral flow between the main channel CM and the auxiliary channel CA at least in a vertical direction.

The first partition wall 252 thus extends horizontally from the second partition wall 254 to the side of the upper portion of the internal wall surface 105.

The second partition wall portion 254 extends axially between the first partition edge 210 and the second partition edge 290, and comprises a first lateral edge 257 fixedly connected to a lower portion 106 of the internal wall surface 105 of the housing 100, and a second lateral edge 258 fixedly joined to the second partition wall portion 254, for example to the second lateral edge 253 thereof. The second wall portion 254 essentially prevents lateral flow between the main channel CM and the auxiliary channel CA at least in a horizontal direction.

The second partition wall 254 thus extends vertically from the first partition wall 252 to the bottom of the lower portion of internal wall surface 105.

Thus, in at least this example, the partition wall 250 extends from the inner surface 105 of the housing 100, in both a horizontal direction and in a vertical direction.

Referring again to FIG. 10, the first electrolysis chamber axial end 932 is axially spaced with respect to the first water flow opening by a third axial spacing X3, and the second electrolysis chamber axial end 934 is axially spaced with respect to the second water flow opening 190 by a fourth axial spacing X4. For example, a ratio of said first axial spacing X1 to said third axial spacing X3 is in any one of the following ranges: 0.2 to 0.8; 0.5 to 0.7; 0.2 to 0.5. For example, a ratio of said second axial spacing X2 to said fourth axial spacing X4 is in any one of the following ranges: 0.2 to 0.8; 0.5 to 0.7; 0.2 to 0.5.

In at least these examples, the first partition edge 210 projects axially away from, and is thus axially spaced from, the first electrolysis chamber axial end 932 by a fifth axial spacing X5, wherein:

X5=X3−X1

In at least these examples, the second partition edge 290 projects axially away from, and is thus axially spaced from, the second electrolysis chamber axial end 934 by a sixth axial spacing X6, wherein:

X6=X4−X2

It is to be noted that the electrolysis chamber 130 also has a seventh axial spacing X7, between the first electrolysis chamber axial end 932 and the second electrolysis chamber axial end 934; the seventh axial spacing X7 thus defines an axial dimension of the electrolysis chamber 130. Referring again to FIG. 7, the partition wall 250, in particular the second partition

wall portion 254, comprises a shoulder or ridge 285 that acts as a stop for engaging with the electrode assembly 900 and facilitating engagement and/or positioning of the electrode assembly 900 with the housing 100.

As disclosed above, the housing 100 comprises sampling chamber 170, and the flow separator 200 operates, in operation of the chlorinator, to separate water flowing into the housing 100 (in the aforesaid first installation configuration—via the first water flow opening 110; in the aforesaid second installation configuration—via the second water flow opening 190) into the main water stream WSM and the auxiliary water stream WSA. The main water stream WSM flows through the main channel CM and thus through the electrode chamber 130 (and thus through the electrode assembly 900). The auxiliary water stream WSA flows through the auxiliary channel CA and thus through the sampling chamber 170.

The auxiliary channel CA extends axially between the first auxiliary channel opening 215 defined at the first partition edge 210, and the second auxiliary channel opening 295 defined at the second partition edge 290. The sampling chamber 170 is axially wholly accommodated in the auxiliary channel CA, i.e., the sampling chamber 170 is wholly accommodated axially between the first auxiliary channel opening 215 and the second auxiliary channel opening 295 (i.e., the sampling chamber 170 is axially wholly accommodated in an axial direction parallel to the longitudinal axis LA, axially between the first partition edge 210, and the second partition edge 290), on a second side S2 of the partition wall 250. In other words, there are no sampling ports or sensors provided in the sampling chamber 170 (or in the housing 100) other than axially between the first auxiliary channel opening 215 and the second auxiliary channel opening 295, i.e., axially between the first partition edge 210 and the second partition edge 290.

The sampling chamber 170 is configured for enabling sampling of the auxiliary water stream WSA during operation of the chlorinator 10. Such sampling can be carried out for the purpose of determining one or more of predetermined water parameters relating to the auxiliary water stream WSA, and thus to the water flowing through the chlorinator 10. Without being bound to theory, inventors consider that the flow separator 200 separates the incoming water into the main water stream WSM and the auxiliary water stream WSA sufficiently upstream of the electrode assembly 900, such that electrolysis operation of the electrode assembly 900 will not significantly affect the aforementioned water parameters of the auxiliary water stream WSA, while such operation is considered to significantly affect at least some of the water parameters of the main water stream WSM. Thus, it is possible to conduct such sampling concurrent with the electrode assembly 900 operating to provide electrolysis.

For example, such water parameters are generally considered to provide indications of quality of water flowing through the chlorinator 10, and can include for example one or more of the following: pH, temperature, salinity, chlorine level, oxidation/reduction (ORP) potential, level of contaminants in the water, and so on.

The water parameters are sensed via corresponding sensors 180 that are operatively coupled to a suitable controller, for example the control unit 940 and/or an external controller, for example controller 951 that forms part of the water recirculation circuit 950.

In at least this example, the sensors 180 are in the form of respective sensor probes 182 that are elongate and have a respective longitudinal first end 181 and a respect longitudinal second end 183. Each first end 181 comprises the sensor sensing end, and is configured to enable the sensor 180 to become in contact with the auxiliary water stream WSA in the sampling chamber 170 during operation of the chlorinator 10. Each second end 183 is configured for transmitting a signal to the controller, for example the control unit 940 and/or an external controller, for example controller 951 that forms part of the water recirculation circuit 950, indicative of a value of the water parameter being sensed by the respective sensor 180.

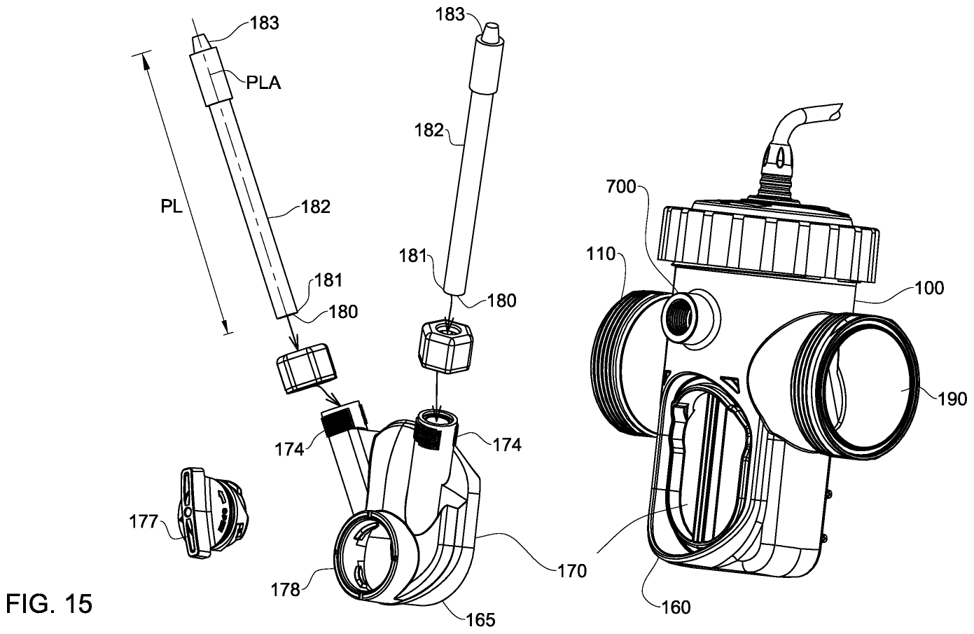

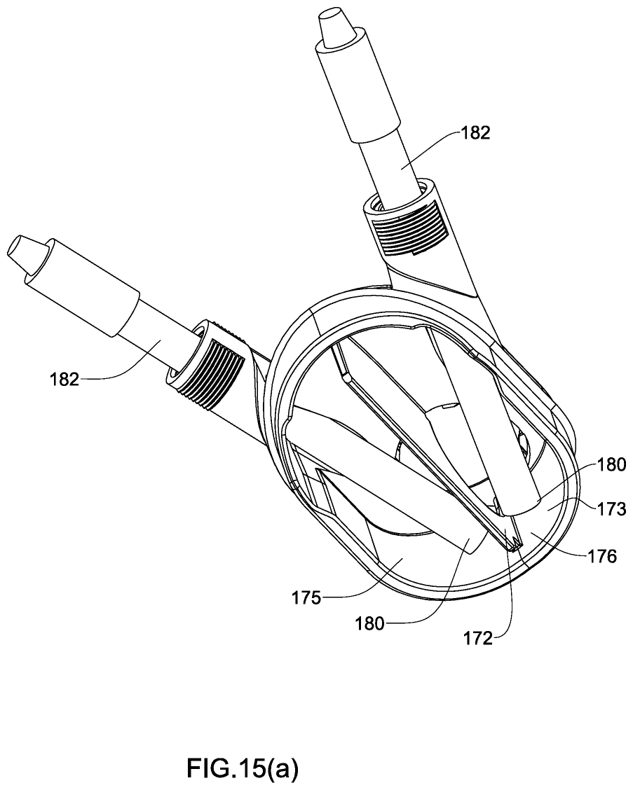

In at least some examples, and referring for example to FIG. 11 and FIG. 15, each sensor probe 182 can have a longitudinal length PL (for example between 15 cm and 20 cm, for example 15.6 cm), and the sampling chamber 170 has a depth dimension DD (along the vertical axis VA). In at least this this example, the depth dimension DD is such to enable accommodating therein that more than 50% of the probe longitudinal length PL, for example, more than any one of 40%, 45%, 50%, 55%, 60% of the probe longitudinal length PL.

Referring in particular to FIG. 11, the sampling chamber 170 has a with dimension WD (parallel to the longitudinal axis PA). In at least this example, the depth dimension DD is greater than the with dimension WD. In at least one implementation of this example, the depth dimension DD is about 70 mm, and the with dimension WD is about 95 mm, such that the respective ratio of the depth dimension DD to the with dimension WD is about 1.4. In this or other examples, the respective ratio of the depth dimension DD to the with dimension WD can be in the range for example from about 1.2 to about 2.5.

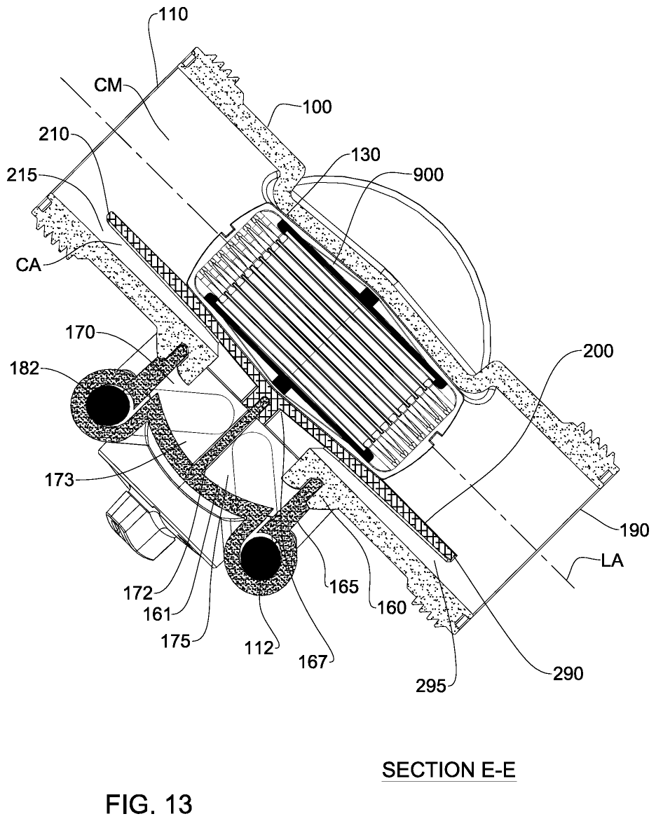

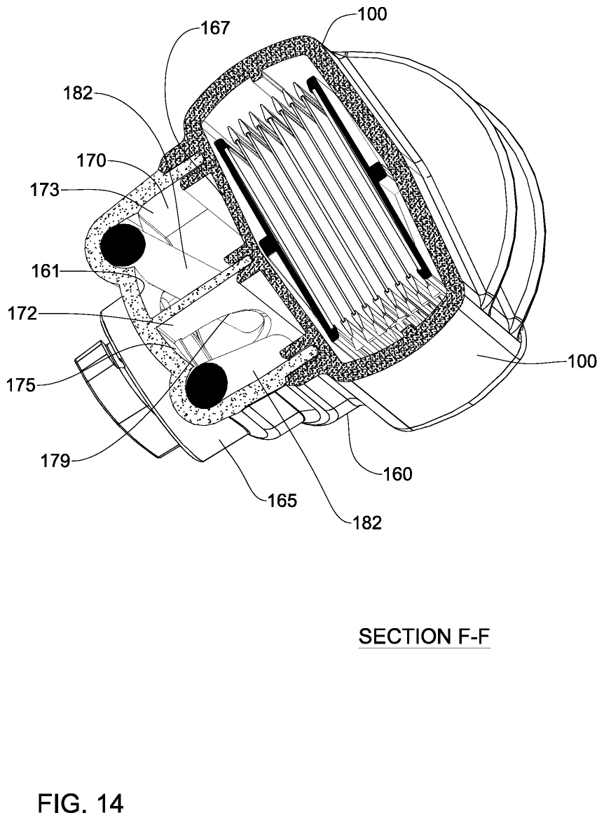

In at least this example, and as can be best seen in FIG. 2(a), FIG. 13, FIGS. 14 and FIG. 15(a), the two sensor probes 182 are accommodated within the sampling chamber 170, one in each of the two sub-chambers 173, 175 of the sampling chamber 170.

In at least this example, and as can be best seen in FIG. 2(a), the two sensor probes 182 are accommodated within the sampling chamber 170 in a near vertical direction. For example the longitudinal axis PLA of each sensor probe 182 is at an angle a to the vertical axis VA, when viewed from the front, for example as in FIG. 2 or FIG. 2(a). For example, in at least this example, angle a is in the range 0° to ±25°, for example ±20°, and in alternative variations of this example, the inclination angle α can be in the range 0° to ±45°.

While in the illustrated example two sensors 180 are illustrated, in alternative variations of this example the sampling chamber 170 can be configured for receiving only one sensor, or more than two sensors, each of which can be provided at the respective first end of the respective sensor probe, or via any other suitable arrangement.

As best seen in FIG. 13, the sampling chamber 170 is laterally displaced with respect to the electrolysis chamber 130.

Referring to FIG. 13, FIG. 14, and FIG. 15, in at least this example, the sampling chamber 170 is provided by a front portion of the housing 100. For convenience in manufacture, for example, the sampling chamber 170 can be defined between a suitably molded front portion 160 of the housing 100 and a suitably molded sampling chamber outer cover 165. As best seen in FIG. 13, the front portion 160 of the housing 100 and the sampling chamber outer cover 165 couple together in a water-tight manner to define therebetween the sampling chamber 170.

In at least this example, the sampling chamber 170 optionally comprises a laterally disposed access hatch 178 that can be selectively sealingly closed or opened via cap 177.

The sampling chamber 170 is separated into two halves, referred to herein as sub-chambers 173, 175, via a flow diverter in the form of sampling chamber wall 172. The sampling chamber wall 172 acts as a barrier wall inside the sampling chamber, and transversely projects in the auxiliary channel CA with respect to the longitudinal axis LA of the housing 100. In at least this example, the sampling chamber wall 172 acts as a barrier wall inside the sampling chamber, and transversely projects away from the second side of the partition wall 250.

Thus, the sampling chamber wall 172 essentially extends laterally between the respective facing inside surfaces 161, 167 of the front portion 160 of the housing 100 and the sampling chamber outer cover 165, the inside surface 167 being of the second partition wall portion 254. The sampling chamber wall 172 also essentially extends vertically between an underside of the first partition wall portion 252 and the bottom portion of the internal wall surface 105. An opening 179 is provided in the sampling chamber wall 172, allowing water to flow between the two halves of the sampling chamber 170. The opening 179 is provided at a lower part of the sampling chamber wall 172, close to the position of the sensors 180.

The sampling chamber 170 comprises a plurality of ports 174, each port 174 being configured for enabling a sensor 180, via the respective sensor probe 182, to be introduced into the sampling chamber 170 from an outside of the housing 100. In at least some alternative variations of this example, the respective sampling chamber comprises a single sampling port, configured for enabling a sensor to be introduced into the sampling chamber 170 from an outside of the housing.

The sampling chamber wall 172 also functions as a flow diverter, configured for causing the auxiliary water stream WSA to change direction by an angle greater than 60°, and typically about 80°±10° when flowing through the auxiliary channel CA, from the first auxiliary channel opening 215 and into the adjacent half of the sampling chamber 170 (in the first installation configuration), or from the second auxiliary channel opening 295 and into the other adjacent half of the sampling chamber 170 (in the second installation configuration).

The opening 179 allows water to flow from one half of the sampling chamber 170 to the other half of the sampling chamber 170. The water flowing through the opening 179 essentially changes direction by nominally 180°.

In the first installation configuration, the auxiliary water stream WSA enters the auxiliary channel CA at the first auxiliary channel opening 215 and into the respective adjacent half of the sampling chamber 170, and is then diverted by the sampling chamber wall 172 through the opening 179 and into the other half of the sampling chamber 170, and then out of the auxiliary channel CA via the second auxiliary channel opening 295.

In the second installation configuration, the auxiliary water stream WSA enters the auxiliary channel CA at the second auxiliary channel opening 295 and into the respective adjacent half of the sampling chamber 170, and is then diverted by the sampling chamber wall 172 through the opening 179 and into the other half of the sampling chamber 170, and then out of the auxiliary channel CA via the first auxiliary channel opening 215.

It is to be noted that in the aforesaid arrangement of the sampling chamber 170, in which the sampling chamber wall 172 acts as a barrier wall inside the sampling chamber, such an arrangement can operate to provide a drop in pressure in the sampling chamber 170, and thus in the auxiliary channel CA, between the first auxiliary channel opening 215 and the second auxiliary channel opening 295. This pressure drop can also result in a reduction in the flow velocity of the auxiliary water stream WSA in the auxiliary channel CA, which can be beneficial in terms of facilitating operation of the sensors in the sampling chamber 170.

It is also to be noted that in the aforesaid arrangement of the sampling chamber 170, the sampling chamber 170 is essentially configured with a first passage (sub-chamber 173 or sub-chamber 175, depending in the flow direction (i.e., corresponding to the first installation configuration or the second installation configuration)) configured to for essentially forcing the flow of water from the auxiliary water stream WSA entering the auxiliary channel CA to the bottom 176 of the sampling chamber 170, and with a second passage (the other one of sub-chamber 173 or sub-chamber 175) configured for essentially forcing the flow of water from the bottom of the sampling chamber 170, and out of the auxiliary channel CA.

As such, at least a lower section of the first passage and the second passage (i.e., the blower section of the chamber 173 and sub-chamber 175, functions as a water trap (also referred to as a “siphon”), essentially trapping therein a volume of water. Such a lower section is at least of a height dimension along the vertical axis VA such as to include at least the sensing ends of the sensor probes 182.

This water trap feature can ensure that water remains trapped in the aforesaid lower section, even if the level of water in the internal volume VI reaches the lowermost point of the inlet end 110 or the outlet end 190. Such a reduction of the water level can occur, for example, when the reticulation circuit 950 is being depleted of water.

Thus, in at least this example, in operation of the chlorinator 10, the chlorinator 10 is oriented such that the bottom 176 of the sampling chamber 170 is gravitationally below the main channel CM. Furthermore, in at least this example the chlorinator 10 is oriented such that the bottom 176 of the sampling chamber 170 is gravitationally below the acid port 700.

In at least some examples, it can be beneficial for the sensing ends of the sensor probes 182 to be continually immersed in water.

In alternative variations of at least the above examples, the sampling chamber can include a U-tube arrangement, in which one arm of the “U” corresponds to the sub-chamber 173, and the other arm of the “U” corresponds to the sub-chamber 175, and in which the respective sensor probes are accommodated one in each of the two arms.

According to a second aspect of the presently disclosed subject matter, and referring again in particular to FIGS. 1 to 7, and FIG. 15, the housing 100 comprises an acid port 700 and a sampling chamber shielding arrangement.

The acid port 700 is configured for selectively enabling introduction of an acid therethrough and into the electrolysis chamber 130. In particular, the acid port 700 is configured for selectively enabling introduction of an acid therethrough and transversely directly into the electrolysis chamber 130.

The acid port 700 has an entry side projecting outside of the housing 100, and an exit side projecting directly into the housing 100. In particular, the exit side of the acid port 700 is laterally directly facing the electrode chamber 190.

For example, the acid port 700 can be selectively connected to a source of acid at least when it is necessary to top up the housing internal volume VI with such acid. Optionally, the acid port 700 can be closed with a suitable cap (not shown) when it is not necessary to provide additional acid to the internal volume VI.

Such an acid can be utilized for regulating the level of pH in the internal volume VI, and particularly in the main channel CM, and can reduce scaling on the electrolysis plates 930 of the electrode assembly 900. Such an acid can include hydrochloric acid (HCl) or any other suitable acid, for example.

In operation of the chlorinator 10, such acid can be introduced into the main channel CM of the internal volume VI, when there is an absence of water flowing through the chlorinator 10.

While in this example the housing 100 comprises a single acid port 700, in alternative variations of this example, the housing 100 can instead comprise a plurality of acid ports, each being configured for selectively enabling introduction of an acid therethrough and into the electrolysis chamber 130.

According to the second aspect of the presently disclosed subject matter, the sampling chamber shielding arrangement is configured for minimizing or preventing spill of the acid into the sampling chamber 170 following introduction of the acid into the housing 100 via the at least one acid entry port 700.

The sampling chamber 170 is transversely separated from the at least one acid entry port 700 by the sampling chamber shielding arrangement.

The sampling chamber shielding arrangement is configured for preventing transverse fluid communication therethrough, in particular for preventing transverse fluid communication through the shielding arrangement between the at least one acid entry port 700 and the sampling chamber 170.

In particular, the sampling chamber shielding arrangement is transversely interposed between the acid port 700 and the sampling chamber 170, thereby blocking transverse fluid communication between the acid port 700 and the sampling chamber 170, and thereby enabling minimizing or preventing spill of the acid into the sampling chamber 170 following introduction of the acid into the housing 100 via the at least one acid entry port 700.

In at least this example, the flow stream separator 200 also functions as the sampling chamber shielding arrangement, in conjunction with the acid port 700 being axially intermediate with respect to each one of the first axial edge 210 and the second axial edge 290 of the flow stream separator 200. Conversely, in at least this example the sampling chamber shielding arrangement also functions as the flow stream separator 200 of the first aspect of the presently disclosed subject matter.

However, it is to be noted that in other alternative variations of this example, in a similar manner to the flow stream separator 200 as disclosed herein, mutatis mutandis:
the respective shielding wall also separates the housing internal volume VI into a main channel and an auxiliary channel, the main channel extending axially between said first axial edge and said second axial edge, and wholly accommodating therein the electrolysis chamber on a first side of the shielding wall, the auxiliary channel extending axially between the first axial edge and the second axial edge and wholly accommodating therein the sampling chamber on a second side of the shielding wall;
the shielding wall transversely separates the housing internal volume into the main channel and the auxiliary channel;
the shielding wall is impermeable to water, for example pool water.

According to the second aspect of the presently disclosed subject matter, the at least one acid port 700 is wholly located in the main channel CM.

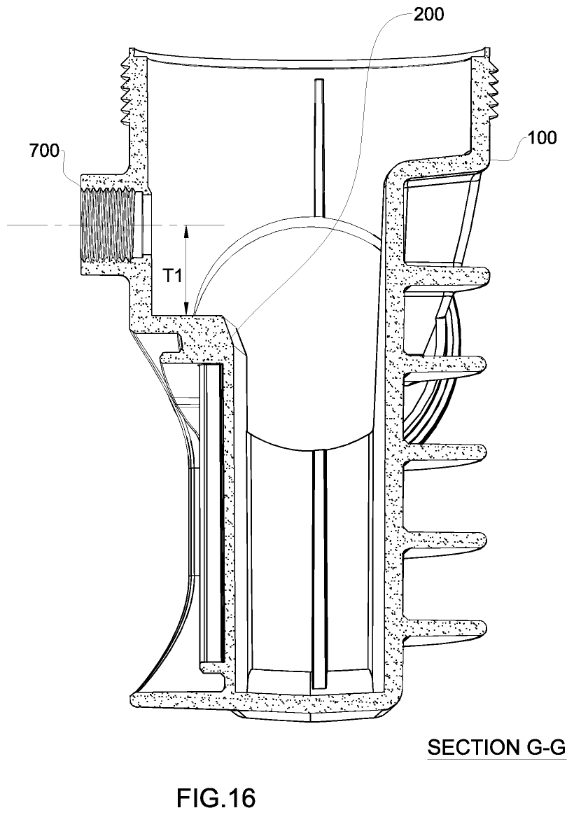

Referring to FIG. 16, the acid entry port 700 is transversely spaced from the shielding wall, in at least this example from the flow stream separator 200, by a first vertical spacing T1. The first vertical spacing T1 is taken vertically between a centerline of the acid entry port 700 and the top surface of the flow stream separator 200, in particular of the first portion 252 thereof.

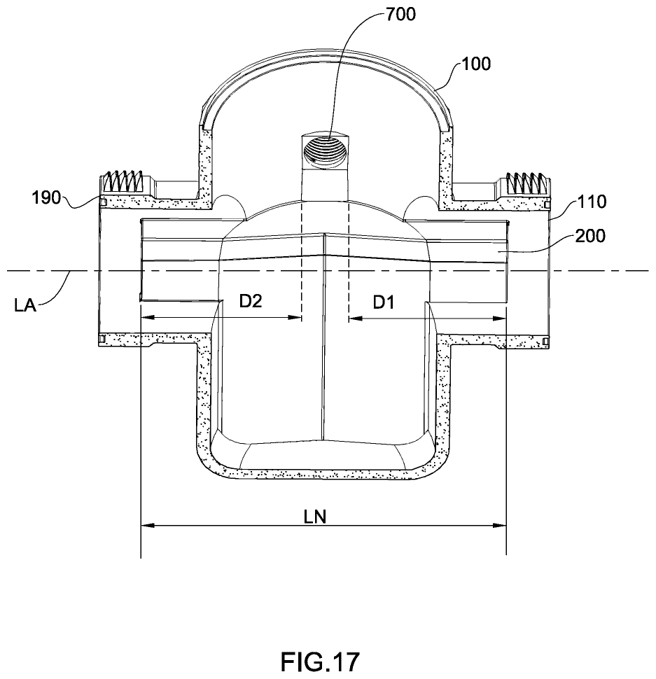

Referring also to FIG. 17, the shielding wall (in at least this example, the flow stream separator 200 and the shielding wall are one and the same component) has a shielding wall axial length LN, which also referring to FIG. 10 in at least this example is also the summation of the fifth axial spacing X5, the sixth axial spacing X6, and the seventh axial spacing X7.

In at least this example, a ratio of the first vertical spacing T1 to the shielding wall axial length LN is within at least one of the following ranges: between 0.05 to 0.15; between 0.03 to 0.20.

In at least this example, and referring again to FIG. 17, the first axial edge 215 extends away from the acid entry port 700 (in particular, from the part of the edge of acid entry port 700 that is closest to the first axial edge 215) towards the first water flow opening 110 by a first axial distance D1.

Similarly, the second axial edge 295 extends away from the acid entry port 700 (in particular, from the part of the edge of acid entry port 700 that is closest to the second axial edge 295) towards the second water flow opening 190 by a second axial distance D2.

In at least this example, the first axial distance D1 is equal to the second axial distance D2. Moreover, in at least this example, both the first axial distance D1 and the second axial distance D2 are non-zero.

However, it is to be noted that in at least some alternative variations of this example, only one of the first D1 and the second axial distance D2 can be non-zero, while the other one of the first axial distance D1 and the second axial distance D2 is zero. In such examples, the respective housing is not two-directional, and flow through the respective housing is either according to the first installation configuration only, or according to the second installation configuration only.

In yet other alternative variations of this example, the first axial distance D1 and the second axial distance D2 can be non-equal to one another. In yet other alternative variations of this example, both the first axial distance D1 and the second axial distance D2 can extend to the respective first water flow opening 110 and the respective second water flow opening 190. In yet other alternative variations of this example, the first axial distance D1 and/or the second axial distance D2 can extend further to respectively project out of the housing 100 via the respective first water flow opening 110 or the respective second water flow opening 190; in such cases, the respective first partition edge 210 and/or the respective second partition edge 290 project into the respective portion of piping of the recirculation circuit 950 that is connected to the first water flow opening 110 or the second water flow opening 190, respectively.

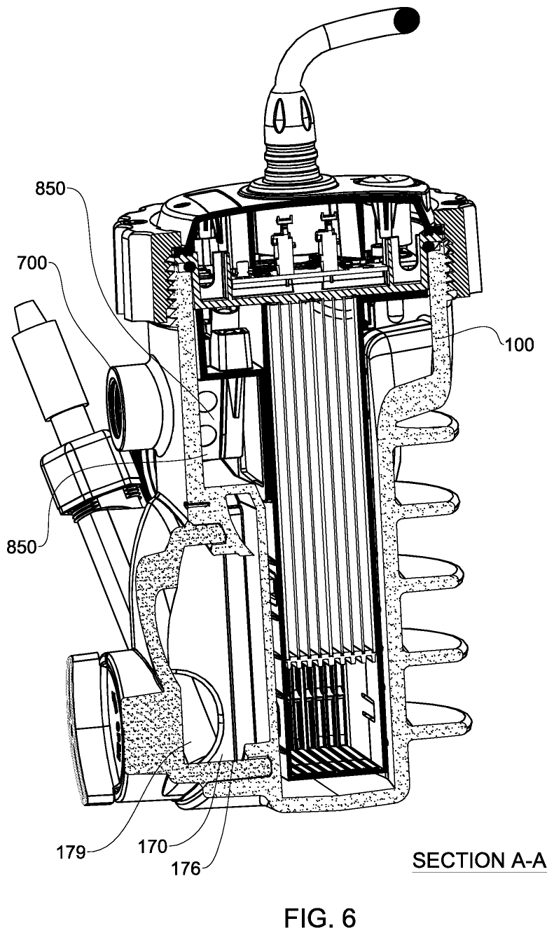

In at least this example, said first axial distance D1 is about 30% of an axial dimension of the housing, and the second axial distance D2 is about 30% of an axial dimension of the housing. Referring again to FIGS. 6, 7, 8, the chlorinator 10 further optionally comprises a fluid flow sensor arrangement 850 for detecting the presence of flow of water inside the housing 100, in particular inside the main channel CM.

The fluid flow sensor arrangement 850 is operatively coupled to a suitable controller, for example the control unit 940 and/or an external controller, for example controller 951 that forms part of the water recirculation circuit 950.

The fluid flow sensor arrangement 850 provides suitable signals to the control unit 940 and/or an external controller that can form part of the water recirculation circuit 950, which can then control operation of the electrolysis assembly 900, such that the electrodes are not electrolyzing in the absence of water actually flowing through the main channel CM and thus through the electrolysis assembly 900.

In at least this example, the fluid flow sensor arrangement 850 operates to sense the flow of water in either direction through the chlorinator 10, i.e., regardless of whether the chlorinator 10 is installed in the first installation configuration or in the second installation configuration. In other words, the fluid flow sensor arrangement 850 is configured to detect flow of water in the electrolysis chamber 230 across the electrolysis plates 930, while being insensitive to the direction of flow; accordingly, the chlorinator 10 can be installed without regard to flow direction therethrough.

In at least this example, the fluid flow sensor arrangement 850 is in the form of or comprises a bidirectional mechanical flow sensor. The fluid flow sensor arrangement 850 comprises a paddle 852 pivotally mounted on a shaft 851 so as to pivot freely thereabout. The paddle 852 is disposed such that surfaces 852a, 852b thereof are substantially perpendicular to the direction of flow of water, e.g., perpendicular to the electrolysis plates 930. Stoppers (not shown) are provided adjacent the paddle 852 to limit its movement. A top end of the paddle 852 comprises a sensing magnet 853 therein. A magnet sensor configured to detect the presence or absence of the sensing magnet 853 therebelow, such as a reed switch 856, is provided above the paddle, e.g., in the control unit 940.

The mechanical flow sensor 850 can further comprise a centering arrangement configured to ensure that, in the absence of any external force on the paddle 852, such as from a flow of water thereacross, the paddle 852 remains in a vertical, non-tilted, position. According to some examples, two sockets 857, each having a positioning magnet 858 therein, are provided adjacent the top of the paddle 852. Equal forces exerted by each of the positioning magnets 858 on the sensing magnet 853 maintain the paddle 852, in the absence of a flow of water past it, in a neutral position which is substantially perpendicular to the path via which water flows, for example nominally parallel to the longitudinal axis LA. The positioning magnets 858 can be arranged such that the dominant magnetic force exerted on the sensing magnet 853 is a repelling magnetic force, i.e., they are each aligned such that the pole thereof (north or south) which faces the sensing magnet 853 is the same as the pole of the sensing magnet closer thereto, i.e., the positioning magnet closer to the north pole of the sensing magnet is aligned with its north pole facing the sensing magnet, and the magnet closer to the south pole of the sensing magnet is aligned with its south pole facing the sensing magnet.

According to other examples (not illustrated), biasing elements, such as springs, are provided to impart equal, but oppositely directed, forces on the paddle 852 when in its rest position, for example above the shaft 851.

It will be appreciated that the centering arrangement as described above is completely external to the paddle 852, i.e., it does not require the addition of any elements to the paddle itself which it does not already comprise for the its use to sense flow of water (e.g., in the example given above relating to the positioning magnets 858, the sensing magnet 853, which the paddle requires for flow sensing, is utilized as well for centering thereof in the absence of flow).

In operation, the centering arrangement maintains the paddle 852 is a vertical rest position, such that the sensing magnet 853 is directly below the reed switch 856. When a flow of water develops, thereby pivoting the paddle 852, the sensing magnet 853 moves away from the reed switch 856, which detects the change, thereby determining the presence of a flow of water through the electrolysis chamber 130. When the flow ceases, the paddle 852 returns to its neutral position, with the sensing magnet 853 below the reed switch 856, which senses the sensing magnet 853, determining that there is no flow of water through the electrolysis chamber 130.

It will be appreciated that while in the example of the fluid flow sensor arrangement 850 described above comprises two positioning magnets to maintain the paddle 852 in its neutral position, in alternative variations of this example the fluid flow sensor arrangement 850 can be provided comprising any suitable number of magnets without departing from the scope of the presently disclosed subject matter, mutatis mutandis.

The outputs from the fluid flow sensor arrangement 850 thus enable determining the state of flow through the electrolysis chamber 130, to thereby enable the control unit 940 to operate the electrode assembly 900 only when there is a flow of water through the chlorinator 10, and to stop electrolysis when there is no flow through the chlorinator 10.

In at least this example, in operation of the chlorinator 10, the control unit 940 is configured to receive input regarding the level and/or the change in parameters of the water, from the sensors 180 of the chlorinator 10 and/or from sensors external thereto, and to vary the rate of electrolysis (for example by varying the electrical power provided to the electrolysis plates 930) in response thereto. These parameters may include, but are not limited to, one or more of pH level, salinity, chlorine level, oxidation/reduction (ORP) potential, level of contaminants in the water, or temperature. For example, the control unit 940 can be configured to decrease the current output by the power supply to the electrolysis plates 930, and thereby lower the rate of electrolysis, in response to a detected drop in the salinity of the water.

The control unit 940 can be further configured to receive an input from a user, for example via a user interface, or an external operating system (e.g., a system configured to pump water through the chlorinator 10, a system configured to supply salt to the water, and so on) to increase and/or decrease the rate of electrolysis, and to direct operation of the power supply accordingly. These inputs can include, but are not limited to, one or more of a desired level of chlorination, a flow rate of water being pumped to the chlorinator 10, or an unexpected need for an increased level of sanitizing agent in the water.

Referring again to FIG. 7, and as already discussed above, in at least this example, the partition wall 250 extends from the inner surface 105 of the housing 110, in both a horizontal direction and in a vertical direction. In other words, the partition wall 250 has a horizontal component and a vertical component.

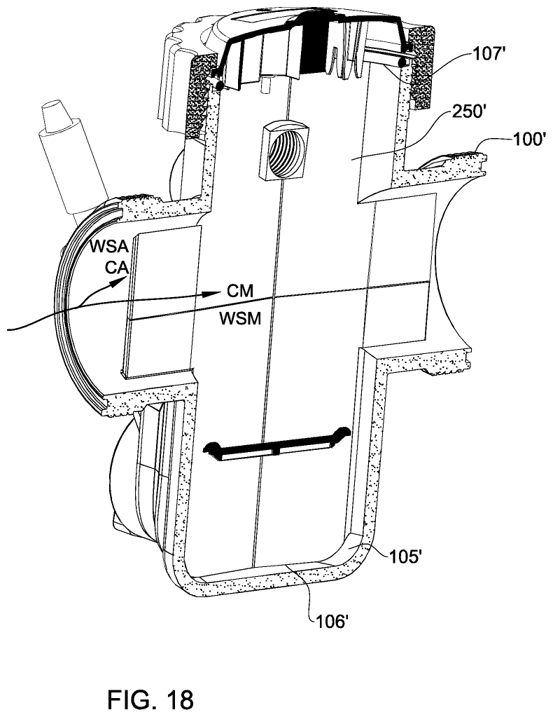

However, in alternative variations of this example, the partition wall can extend from the respective internal wall surface of the housing 110 only in a vertical direction, but not in a horizontal direction. For example, and referring to FIG. 18 for example, the respective partition wall 250′ extends vertically from the respective lower portion 106′ of the respective internal wall surface 105′ of the respective housing 100′ to the respective upper portion 107′ of the respective internal wall surface 105′.

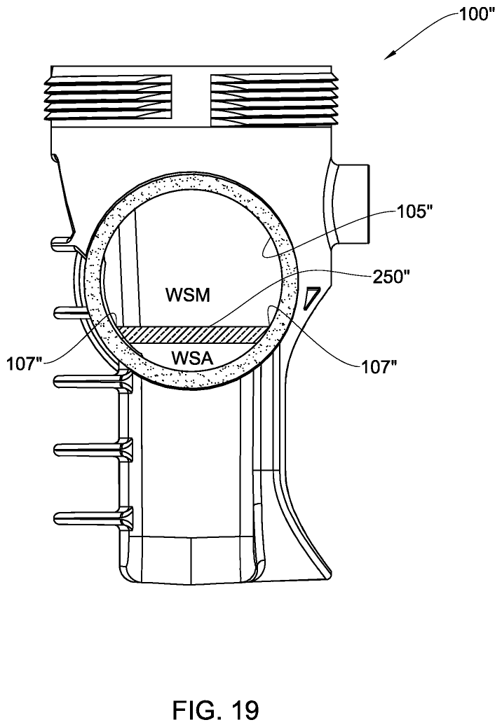

In yet other alternative variations of this example, the respective partition wall 250″ can extend from the respective internal wall surface of the housing 110 only in a horizontal direction, but not in a vertical direction. For example, and referring to FIG. 19 for example, the respective partition wall 250″ can extend laterally between the two opposite sides 109″ of the respective internal wall surface 105″ of the respective housing 100″ to the respective upper portion 107″ of the respective internal wall surface 105″. In such a case, lateral internal conduits (not shown) can direct the respective auxiliary water stream WSA into and out of the respective sampling chamber.

While in the examples illustrated in the figures, the respective housing comprises a single sampling chamber, disposed generally laterally with respect to the electrolysis chamber, other arrangements are also possible. For example, in alternative variations of the above examples, the respective housing can include a plurality of separate sampling chambers, wherein the auxiliary channel suitably bifurcates to provide respective auxiliary flow streams to each sampling chamber. In such a case, each sampling chamber can be provided on a different lateral side of the electrode chamber.

Finally, it should be noted that the word “comprising” as used throughout the appended claims is to be interpreted to mean “including but not limited to”.

While there has been shown and disclosed examples in accordance with the presently disclosed subject matter, it will be appreciated that many changes may be made therein without departing from the scope of the presently disclosed subject matter as set out in the claims.

1. A housing for use in a chlorinator, the chlorinator being operable with an electrode assembly accommodated in the housing to produce one or more sanitizing agents from solute dissolved in water in operation of the chlorinator, said housing comprising a first water flow opening, a second water flow opening, an electrolysis chamber, a sampling chamber, at least one acid entry port, and a sampling chamber shielding arrangement:
the first water flow opening being axially spaced from the second water flow opening and defining therebetween a housing internal volume, the first water flow opening and the second water flow opening configured for being coupled to a source of water in operation of the chlorinator;
said electrolysis chamber being configured for accommodating therein at least a portion of the electrode assembly;
the at least one acid entry port being configured for selectively enabling introduction of an acid therethrough into the electrolysis chamber;
the sampling chamber shielding arrangement being transversely interposed between the at least one acid entry port and the sampling chamber;
the sampling chamber shielding arrangement being configured for preventing transverse fluid communication therethrough.

2. The housing according to claim 1, wherein the sampling chamber shielding arrangement comprises a first axial edge, a second axial edge and a shielding wall, the shielding wall axially extending between the first axial edge and the second axial edge, wherein the at least one acid entry port is axially intermediate with respect to each one of the first axial edge and the second axial edge, and, wherein the shielding wall comprises a first side and an opposite facing second side, wherein the shielding wall separates the housing internal volume into a main channel and an auxiliary channel, the main channel extending axially between said first axial edge and said second axial edge, and wholly accommodating therein the electrolysis chamber on said first side of the shielding wall, the auxiliary channel extending axially between the first axial edge and the second axial edge and wholly accommodating therein the sampling chamber on said second side of the shielding wall.

3. The housing according to claim 2, wherein the at least one acid port is wholly located in said main channel.

4. The housing according to claim 1, including one of:
wherein the at least one acid entry port is transversely spaced from the shielding wall by a first vertical spacing;
wherein the at least one acid entry port is transversely spaced from the shielding wall by a first vertical spacing, and, wherein the shielding wall has a shielding wall axial length, and wherein a ratio of the first vertical spacing to the shielding wall axial length is between 0.05 to 0.15;
wherein the first axial edge extends away from the at least one acid entry port towards the first water flow opening by a first axial distance;
wherein the first axial edge extends away from the at least one acid entry port towards the first water flow opening by a first axial distance, and, wherein said first axial distance is about 30% of an axial dimension of the housing;
wherein the second axial edge extends away from the at least one acid entry port and towards the second water flow opening by a second axial distance;
wherein the second axial edge extends away from the at least one acid entry port and towards the second water flow opening by a second axial distance, and, wherein said second axial distance is about 30% of an axial dimension of the housing.

5. The housing according to claim 2, wherein the shielding arrangement is further configured as a flow separator, the flow separator being configured in operation of the chlorinator for separating at the first axial edge water flowing into the housing via the first water flow opening into a main water stream flowing through the main channel and an auxiliary water stream flowing through the auxiliary channel.

6. The housing according to claim 1, wherein said sampling chamber comprises a flow diverter configured for directing the auxiliary water stream from the first axial edge to a bottom section of the sampling chamber, and for directing the auxiliary water stream from said bottom section to the second axial edge, the flow diverter including a barrier wall in the sampling chamber projecting transversely in the auxiliary channel with respect to a longitudinal axis of the housing, and, wherein said sampling chamber comprises at least one sampling port, each said sampling port configured for enabling a respective sensor to be introduced into the sampling chamber from an outside of the housing.

7. The housing according to claim 1, wherein the housing is configured for being coupled to an inlet conduit and to an outlet conduit of a water recirculation circuit, alternately in each one of a first installation configuration and a second installation configuration, wherein:
in said first installation configuration the first water flow opening operates as a water inlet port and the second water flow opening operates as a water outlet port for the water, such that the first water flow opening is connected to an upstream portion of the water recirculation circuit and receives water flow therefrom, while the second water flow opening is connected to a downstream portion of the water recirculation circuit and delivers water flow thereto;
in second first installation configuration the second water flow opening operates as a water inlet port and the first water flow opening operates as a water outlet port for the water, such that the second water flow opening is connected to an upstream portion of the water recirculation circuit and receives water flow therefrom, while the first water flow opening is connected to a downstream portion of the water recirculation circuit and delivers water flow thereto.

8. A chlorinator, comprising the housing as defined in claim 1, and an electrode assembly accommodated in the electrolysis chamber.

9. The chlorinator according to claim 8, further comprising at least one of: a control unit for controlling operation of the electrode assembly; and a fluid flow sensor arrangement configured for detecting the presence of water flowing inside the housing.

10. A water recirculation circuit including:
at least one chlorinator as defined in claim 8;
a body of water;
a pumping system;
a controller;
an inlet conduit configured for channeling water from the body of water to the chlorinator;
an outlet conduit configured for channeling water from the chlorinator to the body of water.

11. A housing for use in a chlorinator, the chlorinator being operable with an electrode assembly accommodated in the housing to produce one or more sanitizing agents from solute dissolved in water in operation of the chlorinator, said housing comprising a first water flow opening, a second water flow opening, an electrolysis chamber, a sampling chamber, and a flow stream separator:
the first water flow opening being axially spaced from the second water flow opening and defining therebetween a housing internal volume, the first water flow opening and the second water flow opening configured for being coupled to a source of water in operation of the chlorinator;
said electrolysis chamber being configured for accommodating therein at least a portion of the electrode assembly;
the electrolysis chamber axially extending between a first electrolysis chamber axial end and a second electrolysis chamber axial end, the first electrolysis chamber axial end being in fluid communication with the first water flow opening, the second electrolysis chamber axial end being in fluid communication with the second water flow opening;
the sampling chamber configured for selectively enabling sampling of water entering the housing in operation of the chlorinator;
the flow stream separator comprising a first partition edge, a second partition edge and a partition wall, the partition wall axially extending between the first partition edge and the second partition edge;
the partition wall separating the housing internal volume into a main channel and an auxiliary channel, the main channel extending axially between said first partition edge and said second partition edge, and wholly accommodating therein the electrolysis chamber on a first side of the partition wall, the auxiliary channel defined between and extending axially between a first auxiliary channel opening axially defined at the first partition edge and a second auxiliary channel opening axially defined at the second partition edge, the sampling chamber being wholly accommodated axially in the auxiliary channel between the first auxiliary channel opening and the second auxiliary channel opening, on a second side of the partition wall;
the flow separator being configured in operation of the chlorinator for separating at the first partition edge water flowing into the housing via the first water flow opening into a main water stream flowing through the main channel and an auxiliary water stream flowing through the auxiliary channel between the first partition edge and the second partition edge.

12. The housing according to claim 11, wherein said first partition edge defines a first auxiliary channel opening having a first auxiliary channel transverse cross-sectional area, and a first main channel opening having a first main channel transverse cross-sectional area, and, wherein said second partition edge defines a second auxiliary channel opening having a second auxiliary channel transverse cross-sectional area, and a second main channel opening having a second main channel transverse cross-sectional area.

13. The housing according to claim 12, wherein a ratio of said first main channel transverse cross-sectional area to said first auxiliary channel transverse cross-sectional area is at least one of:
in the range between about 7 to about 15;
any one of: 15, 14, 13, 12, 11, 10, 9, 8, 7.

14. The housing according to claim 12, wherein a ratio of said second main channel transverse cross-sectional area to said second auxiliary channel transverse cross-sectional area is any one of:
in the range between about 7 to about 15;
any one of: 15, 14, 13, 12, 11, 10, 9, 8, 7.

15. The housing according to claim 11, wherein said sampling chamber comprises a flow diverter configured for directing the auxiliary water stream from the first axial edge to a bottom section of the sampling chamber, and for directing the auxiliary water stream from said bottom section to the second axial edge, the flow diverter including a barrier wall in the sampling chamber projecting transversely in the auxiliary channel with respect to a longitudinal axis of the housing.

16. The housing according to claim 15, including at least one of:
wherein said barrier wall transversely projects away from the second side of the partition wall;
wherein the sampling chamber including the flow diverter are configured for providing a water trap in operation of the respective chlorinator;
wherein said sampling chamber comprises a plurality of ports, each said port configured for enabling a sensor to be introduced into the sampling chamber from an outside of the housing.

17. The housing according to claim 11, wherein the housing is configured for being coupled to an inlet conduit and to an outlet conduit of a water recirculation circuit, alternately in each one of a first installation configuration and a second installation configuration, wherein:
in said first installation configuration the first water flow opening operates as a water inlet port and the second water flow opening operates as a water outlet port for the water, such that the first water flow opening is connected to an upstream portion of the water recirculation circuit and receives water flow therefrom, while the second water flow opening is connected to a downstream portion of the water recirculation circuit and delivers water flow thereto;
in second first installation configuration the second water flow opening operates as a water inlet port and the first water flow opening operates as a water outlet port for the water, such that the second water flow opening is connected to an upstream portion of the water recirculation circuit and receives water flow therefrom, while the first water flow opening is connected to a downstream portion of the water recirculation circuit and delivers water flow thereto.

18. The housing according to claim 11, further comprising at least one acid entry port, wherein:
the at least one acid entry port is configured for selectively enabling introduction of an acid therethrough into the electrolysis chamber;
the flow stream separator being transversely interposed between the at least one acid entry port and the sampling chamber;
the flow stream separator being configured for preventing transverse fluid communication therethrough.

19. A chlorinator, comprising the housing as defined in claim 11, and an electrode assembly accommodated in the electrolysis chamber.

20. The chlorinator according to claim 19, further comprising at least one of: a control unit for controlling operation of the electrode assembly; and, a fluid flow sensor arrangement configured for detecting the presence of water flowing inside the housing.

21. A water recirculation circuit including:
at least one chlorinator as defined in claim 19;
a body of water;
a pumping system;
a controller;
an inlet conduit configured for channeling water from the body of water to the chlorinator;
an outlet conduit configured for channeling water from the chlorinator to the body of water.

22. The water recirculation circuit according to claim 21, wherein the chlorinator is installed in one of a first installation configuration and a second installation, wherein:
in the first installation configuration the first water flow opening is connected to said inlet conduit such as to receive water flow therefrom, and wherein the second water flow opening is connected to said outlet conduit such as to deliver water flow thereto, during operation of the chlorinator;
in the second installation configuration the second water flow opening is connected to said inlet conduit such as to receive water flow therefrom, and wherein the first water flow opening is connected to said outlet conduit such as to deliver water flow thereto, during operation of the chlorinator.

23. A housing for use in a chlorinator, the chlorinator being operable with an electrode assembly accommodated in the housing to produce one or more sanitizing agents from solute dissolved in water in operation of the chlorinator, said housing comprising a first water flow opening, a second water flow opening, an electrolysis chamber, a sampling chamber:
the first water flow opening being axially spaced from the second water flow opening and defining therebetween a housing internal volume, the first water flow opening and the second water flow opening configured for being coupled to a source of water in operation of the chlorinator;
said electrolysis chamber being configured for accommodating therein at least a portion of the electrode assembly;
the housing being configured in operation of the chlorinator for separating water flowing into the housing via the first water flow opening into a main water stream flowing through a main channel and an auxiliary water stream flowing through an auxiliary channel;
the sampling chamber comprising a flow diverter, the flow diverter including a barrier wall in the sampling chamber and projecting transversely in the auxiliary channel with respect to a longitudinal axis of the housing, the flow diverter configured for directing the auxiliary water stream from a first end of the auxiliary channel to a bottom section of the sampling chamber, and for directing the auxiliary water stream from said bottom section to a second end of the auxiliary channel.

24. A chlorinator, comprising the housing as defined in claim 23, and an electrode assembly accommodated in the electrolysis chamber.

25. A water recirculation circuit including:
at least one chlorinator as defined in claim 24;
a body of water;
a pumping system;
a controller;
an inlet conduit configured for channeling water from the body of water to the chlorinator;
an outlet conduit configured for channeling water from the chlorinator to the body of water.
